(19) United States
(12) Patent Application Publication
(10) Pub. No.: US 2024/0212080 A1
(43) Pub. Date: Jun. 27, 2024

(54) FLEXIBLE, INTEGRATED, FINANCIALLY AWARE GRADUATION OUTCOME PREDICTION SYSTEM

(71) Applicant: The University of North Carolina Charlotte, Charlotte, NC (US)

(72) Inventors: Mohsen Dorodchi, Charlotte, NC (US); Elise Demeter, Huntersville, NC (US)

(21) Appl. No.: 18/541,434

(22) Filed: Dec. 15, 2023

Related U.S. Application Data
(60) Provisional application No. 63/434,575, filed on Dec. 22, 2022.

(51) Int. Cl. G06Q 50/20

(52) U.S. Cl. CPC G06Q 50/2053

(57) ABSTRACT

A model trained with student-specific academic data, student-specific financial data, institutional policy data, and student-specific outcomes is provided. Subject student-related academic data and subject student-related financial data are applied to the model to generate advisor-facing metrics and/or student-facing metrics relating to student progress, such as a financial estimate pertaining to completion of a degree, a predicted student success indicator, and/or the like. A student-facing user interface and advisor-facing user interface facilitates configuration and collaboration of a student-specific academic plan, and intervention by advisor-users. The model is routinely updated and trained online, and an administrator-facing interface enables configuration per institution. Users are notified of alerts or changes in predicted outcomes. The model may include a large language model to facilitate natural language interaction and/or feedback. The system addresses security, privacy, system integration, and customization needs of higher education institutional systems.

### CROSS REFERENCE TO RELATED APPLICATION

This application claims the benefit of priority to U.S. Provisional Application No. 63/434,575, filed Dec. 22, 2022, and titled, “FLEXIBLE, INTEGRATED, FINANCIALLY-AWARE GRADUATION OUTCOME PREDICTION SYSTEM,” the contents of which are hereby incorporated by reference in its entirety.

### GOVERNMENT SUPPORT CLAUSE

This invention was made with government support under 2226797 awarded by the National Science Foundation (NSF). The government has certain rights in the invention.

### TECHNOLOGICAL FIELD

Embodiments of the present disclosure relate generally to machine learning, integration of disparate systems, and facilitation of user interactions, and more particularly, to a flexible, integrated, financially aware graduation outcome prediction system.

### BACKGROUND

Enterprise resource planning (ERP) software is typically used by higher education institutions to house and manage student data for university business purposes. Some higher education ERP systems are surprisingly archaic with outdated programming functionality, poor usability, and limited reporting capabilities. For example, course registration and grade information used by the registrar may be stored in separate data tables from student financial information used by the financial aid office. In this regard, a vast array of data may be available to academic institutions, but are subject to data silos, with student data fractured by data architecture constraints, data privacy laws, and/or the like. Integrating data across multiple sources may require tedious programming by those skilled in ERP system code bases. Certain advising systems, including but not limited to student retention systems, attempt to provide a computer-based facilitation of advising to students, but such systems fall short of achieving many objectives of advisors and counselors due to not only the limited access to disparate sources of data, but also due to the technical challenges associated with identifying meaningful data across varying student populations. Because different institutions, advisors, and student-scenarios may require different methods and data points to assess and advise students, certain advising systems do not reliably produce accurate and meaningful information to its users. The technical challenges significantly impede the ability of such advising systems in providing optimal services to advisors and their students.

### BRIEF SUMMARY OF THE INVENTION

A method, apparatus, and computer program product are therefore provided for providing a flexible, integrated, financially aware graduation outcome prediction system. Colleges and universities are under increasing public pressure to demonstrate their value, keep the cost of a college degree down, and, for public institutions, to serve their enrolled students ever better with less state funding. The public thinks it takes four years to complete a college degree. However, less than half of United States students seeking a baccalaureate degree graduate within four years (US Department of Education, National Center for Education Statistics). About two-thirds graduate within six years. Pell Grant recipients, those undergraduates with the highest financial need who are eligible for federal grants, comprise about a third of the undergraduate population and have even lower graduation success rates (˜40% in six years). Graduation success and how long it takes students to graduate have real-world consequences for students and for society. College dropouts with student loan debt are more likely to default on their loans. Extended time-to-graduation increases the overall cost of a college degree and the debt burden for students with loans. High education institutions that cannot produce sufficient college graduates will risk undermining public perception of the value of a college degree and will fail to meet the national demand for educated workers.

Colleges and universities collect and store massive amounts of data on past and present students. According to certain embodiments, predictive analytics can leverage these data to help higher education institutions better identify which enrolled students could drop out or take more than four years to earn a college degree. Such insights can provide value to institutions looking to strategically target often-limited supportive resources to the right students at the right time, in order to make the biggest possible impact on institutional graduation rates.

As described above, practical and technical challenges have been identified in advising systems and student retention systems. Example embodiments provided herein utilize predictive analytics and interactive user interfaces, among other features, to address these problems. Example embodiments provide a flexible, secure software system capable of integrating with an institutions' existing systems and to provide online, real-time integration of multisource student data into innovative predictive algorithms and useful reporting capabilities to help higher education administrators gain actionable insights from algorithm results. Furthermore, example embodiments offer intervention tools to support students' success, allowing institutions to intervene with students identified by the predictive analytics as potentially at-risk. These include tools to help students create financially-informed long-term academic course plans. Students can receive real-time guidance from intelligent chatbots during their planning work. Example embodiments further provide tools for academic advisors to help them quickly vet students' plans and offer further support and feedback to them.

Example embodiments employ an artificially intelligent software system that may use traditional batch as well as modern online machine learning methods to apply financially-aware predictive machine learning algorithms to undergraduate student's academic and financial aid records to predict graduation outcomes while complying to the security, privacy, system integration, and customization needs of higher education institutional systems.

An apparatus is provided, including at least one processor and at least one memory including computer program code, the at least one memory and the computer program code configured to, with the processor, cause the apparatus to at least access a model trained with at least historical student-specific academic data, historical student-specific financial data, historical institutional policy data, and historical student-specific outcomes, and apply to the model at least one set of subject student-related academic data and subject student-related financial data to generate at least one of: (a) one or more advisor-facing metrics relating to student progress, or (b) one or more student-facing metrics relating to student progress. The one or more student-facing metrics indicate a financial estimate pertaining to completion of a degree and are provided via a student-facing user interface, wherein the student-facing user interface further enables a student-user to configure a student-specific academic plan.

The at least one memory and the computer program code are further configured to, with the processor, cause the apparatus to at least, via the student-facing user interface, enable a student-user to authorize an advisor-user to access the subject student-related financial data.

The one or more advisor-facing metrics indicate at least one of a student-specific academic plan progress status, or a predicted student success indicator, and are provided via an advisor-facing interface. The predicted student success indicator comprises a two-tier hierarchical predictor indicating whether or not a student is predicted to graduate, and if so, whether the student will graduate within a predetermined time period.

The at least one memory and the computer program code are further configured to, with the processor, cause the apparatus to at least facilitate interaction, via an advisor-facing user interface and a student-facing user interface, and between at least one student-user and at least one advisor-user, relating to the at least one of the one or more advisor-facing metrics relating to student progress, or the one or more student-facing metrics relating to student progress.

The at least one memory and the computer program code are further configured to, with the processor, cause the apparatus to at least via an administrator-facing user interface, provide configuration information relating to the training of the model, and via the administrator-facing user interface, enable (a) configuration of data used by the model, and (b) finetuning of parameters used by the model.

The at least one memory and the computer program code are further configured to, with the processor, cause the apparatus to at least routinely update and train the model with at least one of newly received academic data, newly received student-specific financial data, newly received institutional policy data, or newly received student-specific outcomes.

The historical student-specific academic data, historical student-specific financial data, historical institutional policy data, and historical student-specific outcomes are provided from disparate systems.

The at least one memory and the computer program code are further configured to, with the processor, cause the apparatus to at least configure various instances of the model for different institutional systems, and enable further configuration of one or more instances of the model via an administrator-facing user interface.

The at least one memory and the computer program code are further configured to, with the processor, cause the apparatus to at least generate an insight regarding an impact of one of more student-specific academic data, student-specific financial data, or institutional policy data in predicting student-specific outcomes. The at least one memory and the computer program code are further configured to, with the processor, cause the apparatus to at least apply a large language model to the model to generate one or more natural language feedback strings pertaining to a student-specific scenario.

The at least one memory and the computer program code are further configured to, with the processor, cause the apparatus to at least update the model with at least one of newly received academic data, newly received student-specific financial data, newly received institutional policy data, and newly received student-specific outcomes, in response to the update of the model, determine a change in the at least one of the one or more advisor-facing metrics relating to student progress, or the one or more student-facing metrics relating to student progress, such that at least one of: (a) the change, or (b) the changed one or more advisor-facing metrics or student-facing metrics, satisfies an alert criterion, and in response to determining the change, alert at least one of an advisor-user or a student-user of the change.

A computer-implemented method is also provided, including accessing a model trained with at least historical student-specific academic data, historical student-specific financial data, historical institutional policy data, and historical student-specific outcomes, and applying to the model at least one set of subject student-related academic data and subject student-related financial data to generate at least one of: (a) one or more advisor-facing metrics relating to student progress, or (b) one or more student-facing metrics relating to student progress.

An apparatus is also provided, including means for accessing a model trained with at least historical student-specific academic data, historical student-specific financial data, historical institutional policy data, and historical student-specific outcomes, and means for applying to the model at least one set of subject student-related academic data and subject student-related financial data to generate at least one of: (a) one or more advisor-facing metrics relating to student progress, or (b) one or more student-facing metrics relating to student progress.

A computer program product is provided, including at least one non-transitory computer-readable storage medium having computer-executable program code instructions stored therein, the computer-executable program code instructions comprising program code instructions to access a model trained with at least historical student-specific academic data, historical student-specific financial data, historical institutional policy data, and historical student-specific outcomes, and apply to the model at least one set of subject student-related academic data and subject student-related financial data to generate at least one of: (a) one or more advisor-facing metrics relating to student progress, or (b) one or more student-facing metrics relating to student progress.

The above summary is provided merely for purposes of summarizing some example embodiments of the invention so as to provide a basic understanding of some aspects of the invention. Accordingly, it will be appreciated that the above described example embodiments are merely examples and should not be construed to narrow the scope or spirit of the disclosure in any way. It will be appreciated that the scope of the disclosure encompasses many potential embodiments, some of which will be further described below, in addition to those here summarized.

### BRIEF DESCRIPTION OF THE DRAWINGS

FIG. 1 shows one example of a Dockerized architecture that may be utilized according to certain example embodiments;

FIG. 2 shows one example of a system architecture according to certain example embodiments, including modules to facilitate the communications between system layers;

FIGS. 3 and 4 show examples of backend architectures according to certain example embodiments, which are secure and can be integrated to existing enterprise academic systems;

FIG. 5 shows example processes, such as the flow of a data mapping subsystem, of certain example embodiments;

FIG. 6 shows an example of a block diagram of the feature engineering submodule of a machine learning module, according to certain example embodiments;

FIG. 7 shows an example of an online learning submodule of the machine learning module, according to certain example embodiments;

FIG. 8 shows an example of an intelligent conversational agent module, according to certain example embodiments;

FIGS. 9-15, 16A-16G, 17A, 17B, and 18A-18C, and 19 show example user interface displays provided according to certain example embodiments;

FIG. 20 is a block diagram of an apparatus according to certain example embodiments; and

FIGS. 21 and 22 are flowcharts of operations that may be performed according to certain example embodiments.

### DETAILED DESCRIPTION

The present invention now will be described more fully hereinafter in the following detailed description of the invention, in which some, but not all embodiments of the invention are described. Indeed, this invention may be embodied in many different forms and should not be construed as limited to the embodiments set forth herein; rather, these embodiments are provided so that this disclosure will satisfy applicable legal requirements.

As used herein, where a computing device is described to receive data from another computing device, it will be appreciated that the data may be received directly from the other computing device and/or may be received indirectly via one or more intermediary computing devices, such as, for example, one or more servers, relays, routers, network access points, and/or the like. Similarly, where a computing device is described herein to transmit data to another computing device, it will be appreciated that the data may be sent directly to the other computing device or may be sent to the other computing device via one or more interlinking computing devices, such as, for example, one or more servers, relays, routers, network access points, and/or the like.

The terminology used herein is for the purpose of describing particular embodiments only and is not intended to be limiting of the invention. As used herein, the term “and/or” includes any and all combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

Unless otherwise defined, all terms (including technical and scientific terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

In describing the invention, it will be understood that a number of techniques and steps are disclosed. Each of these has individual benefit and each can also be used in conjunction with one or more, or in some cases all, of the other disclosed techniques. Accordingly, for the sake of clarity, this description will refrain from repeating every possible combination of the individual steps in an unnecessary fashion. Nevertheless, the specification and claims should be read with the understanding that such combinations are entirely within the scope of the invention and the claims.

### Overview of Underlying Technologies

### A. Predictive Analytics and Machine Learning Algorithms in Higher Education

Predictive analytic models can help higher education institutions predict the future based on historical patterns and currently available information. Interest in applying predictive analytics techniques to higher education-related problems has grown in recent years, though research in this niche area is still fairly immature. Predictive analytics-related models have been applied to predict answers to higher education-relevant questions such as which students will be retained by an institution, what course enrollment and future course demand will look like for particular areas of study, what students' final course grades will be based on early course data, and which students will take longer than typical to graduate. Many initial advising systems and/or student retention systems used statistical regression techniques, but these techniques are best suited to modeling linear data. Many student data elements, however, are categorical, ordinal or otherwise nonlinear in nature (e.g., demographic information, on-campus/off-campus housing status, good/unsatisfactory academic progress status, transfer student status, etc.). Furthermore, due to changes to the underlying information systems or rules and regulations as well as curriculum, students' data may be collected differently every several years demanding for more “intelligent” approaches and algorithms. As machine learning algorithms have advanced and become more mainstream, more recent work is turning towards these approaches as they are savvier about handling different data types and questions. Example embodiments disclosed herein further improve predictive value in including students' financial aid information in machine learning models to predict graduation outcomes, including predictions about student retention, student drop out, grade point averages, and time-to-degree. Certain example embodiments therefore include financial aid-related features, along with academic and demographic features, to use in training its machine learning algorithms to predict students' graduation outcomes. As there is not a scientific consensus on what types of machine learning algorithms perform best in different education research scenarios, example embodiments provided herein will also allow users to select what type of machine learning model to use, and allow users to customize the inputted features to tailor models appropriately to their student population and context.

Traditional machine learning requires historical data to train on and data where outcomes are unknown to use for prediction applications. This data must be extracted from existing data systems, cleaned and transformed as needed, and loaded into machine learning algorithm scripts. Typically, this would be achieved in higher education settings through ad-hoc requests to data analysts. Even with a usual amount of coding and scripting, this would still be a fairly manual, hands-on, time consuming process and may still not achieve desired outcomes. Many trained models are static and their parameters do not change. As such, machine learning is often done as a one-off or “batch” process. However, in higher education, curriculums change, policies and practices change, and student demographics change over time. This means a static model may lose its accuracy with time, and corresponding software would be impractical to maintain to the extent needed to incorporate the changes. Example embodiments utilize an alternative, but technically very challenging, machine learning approach of online machine learning, which recognizes that as new information comes in there is value in continuously updating and retraining the models. Online machine learning according to example embodiments integrates new data in near real-time, retrains its models, and updates its predictions accordingly. Example embodiments leverage online machine learning techniques to integrate information from student data systems in near real-time, allowing higher education institutions to practically implement machine learning and its insights as an everyday business practice.

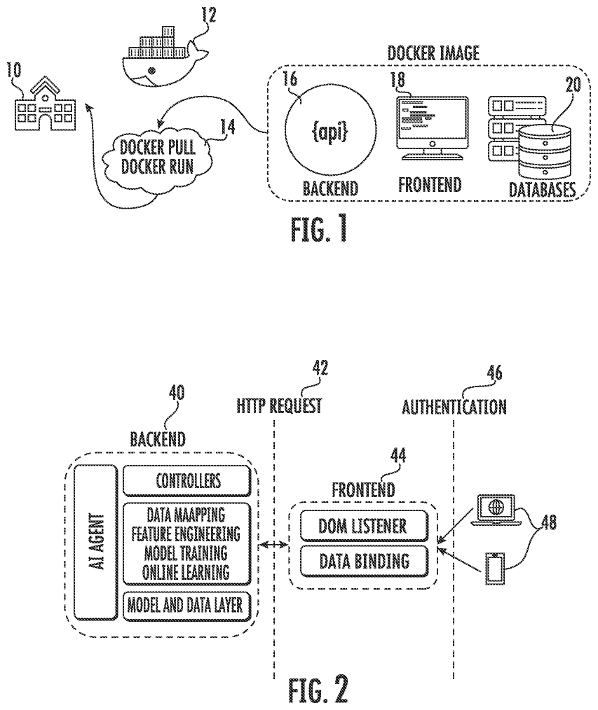

FIG. 1 illustrates a Dockerized system according to example embodiments, and indicates an institutional system 10, Docker subsystem (12 and 14), and a docker image include an application programming interface (API) interfacing with a backend, a user interface frontend 18, and databases 20. Since every institutional system has its own infrastructure and databases and confidential data may not be acceptable often to be stored on third-party servers, example embodiments may publish an application as a web app on local servers rather than software as a service (SAS). Services and dependencies may be Dockerized to achieve this goal. Packing, deploying, and running applications in Docker containers known as Dockerizing. Example embodiments can be packaged with all the necessary functionalities. Therefore, institutions and universities can use Docker to unpack programming code of example embodiments to local systems, which may simplify the deployment process. Additionally, it is a reproducible environment, so customers can easily update the application to the latest versions without any additional requirements which simplifies the software maintenance. This particularly is very important due to the fact that the higher education institutions are often not able to support third party software, however, institutions need to make sure it is contained and interfaces with their infrastructure is a secure and trusted way without incurring security risks and without relying on too many complicated procedures.

FIG. 2 illustrates an example system architecture according to certain example embodiments. This system utilizes an enterprise model of architecture comprising two layers, the frontend layer 44 (including document object model (DOM) listener and data binding) and the backend layer 40 (including an artificial intelligence (AI) agent, controllers, data mapping, feature engineering, model training, online learning, and a model and data layer). Client device 48 is authenticated (46) when accessing frontend 44, and communicates with the backend via a hypertext transfer protocol (HTTP) request 42.

According to example embodiments, a core API is combined with an interactive frontend responsive user interface making the calls to the API utilizing the Model-View-Controller (MVC) design pattern. In this architecture, the model represents the data and business logic, while the view represents the user interface, and the controller mediates communication between the model and the view. According to certain example embodiments, the controller is divided into two distinct subsystems, one for handling standard synchronous requests' access rights to the data sources (e.g., create, read, update and delete (CRUD)) while the other one is managing the online and batch machine learning training processes. According to certain embodiments, an AI agent is responsible for switching between batch and online learning as well as navigating the online learning process based on the user's selection.

The frontend 44 of the system according to certain example embodiments is used by the data scientists as well as school administrators to plan, configure, and execute the creation of the student data models utilizing a spectrum of machine learning algorithms and choice of different students' cohort data.

The frontend may be built using the VueJs framework for interactive JavaScript development, for example. It facilitates the creation of complex and interactive user interfaces by providing a predefined structure and sets of conventions for building web apps with responsive and adaptive layouts. In addition, with the aid of the framework's abundant ecosystem of tools and libraries, different system features are invoked to perform specific tasks such as feature selection and engineering, model creation, training, and performing predictive analytics. This includes libraries for common software engineering structural tasks like routing, state management, and data retrieval, as well as a wide assortment of third-party components and plugins that can be easily integrated into the application. For scalable applications with huge data sizes and multi-users, immediate and real-time system responses need to be provided to the users in spite of the heavy traffic load between the front and backend while handling the increasing number of users and requests without slowing down or possible system crashing due to intensive machine learning tasks. This is accomplished by implementing two-way data binding, reactive components, and server-side rendering in this enterprise application.

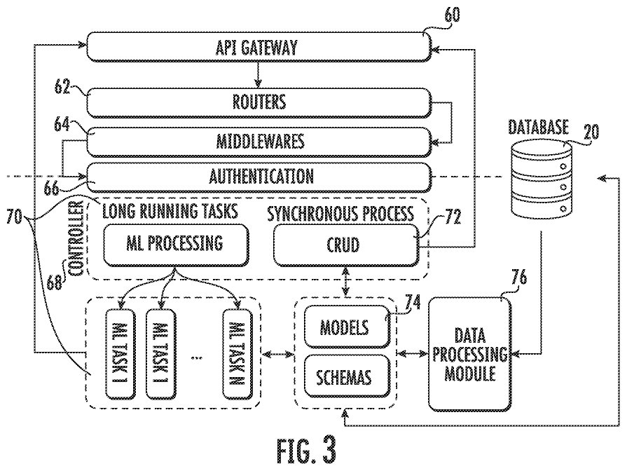

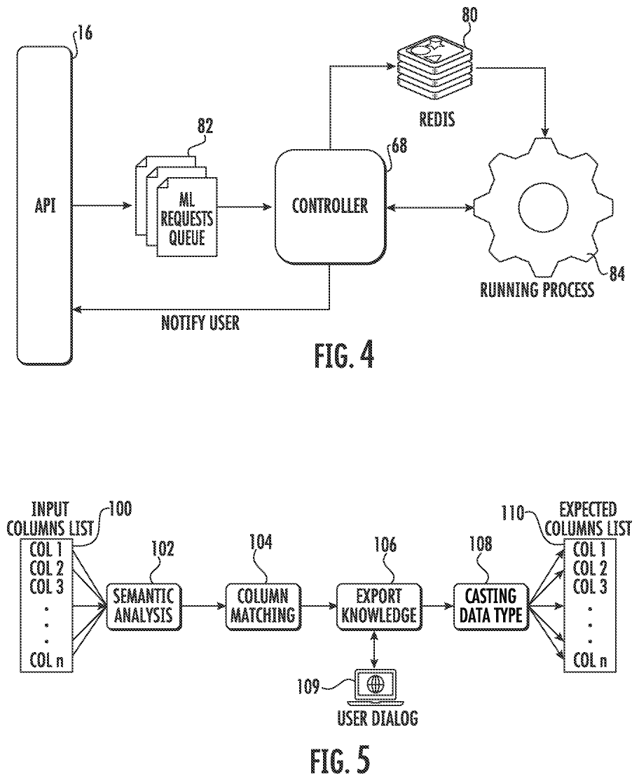

Traditional machine learning requires historical data to train with known outcomes. The data in such systems are fed in batches for training purposes. The backend 40 according to example embodiments is capable of running batches of historical data for training purposes including academic and financial data. FIG. 3 illustrates an example architecture of the backend according to certain example embodiments. HTTP requests are sent through API gateways 60, and after authentication 66 and granting proper data access such as via middleware 64, routers 62 route the request to the controllers 68. A machine learning processing request on large data normally takes a long time to complete particularly when multiple requests are sent to the backend server. Therefore, a custom asynchronous job handler is designed to perform long-running machine-learning tasks 70 outside HTTP requests. As shown in FIG. 4, when the controller 68 receives a request, such as from the machine learning requests queue 82, it sends the job to a task queue using a database, such as Redis 80, and an asynchronous process 84 will notify the user via the API 16 once the job has been completed. Returning to FIG. 3, synchronous processes such as CRUD 72, are invoked via models and schemas 74, to enable the data processing module 76 to access database 20. This would address a major issue in enterprise distributed systems that most higher education institutions have when different systems use shared data and the data does not get updated in real time which may cause problems working with outdated data or waiting too long for updated data.

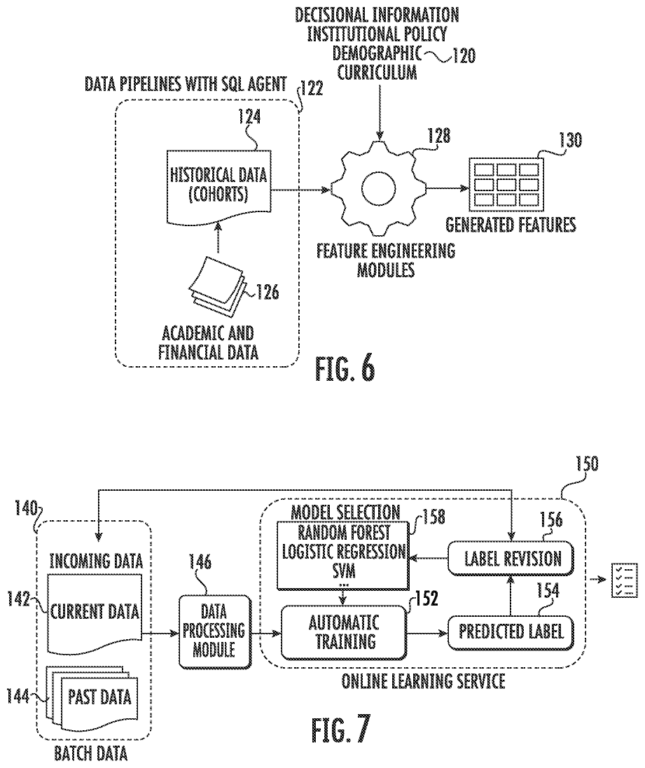

The data source, type, and column names vary from institution to institution, making it technically challenging to retrieve data automatically and/or confusing for data scientists to match their data with a template's tabular data. In order to identify and match each institution data with expected internal data tables, a method including natural language processing is utilized according to example embodiments, and as shown in FIG. 6. First, the desired features are extracted from the column names 100 using Lexical and Compositional Semantic Analysis and Natural Language Processing (NLP) guided by expert insights. According to example embodiments, the data mapping process may include semantic analysis 102, and column matching 104, to export knowledge 106. The system, according to example embodiments, then begins matching the columns and recommends them to the user (i.e., data scientist) via user dialog 109. Furthermore, the user can easily edit matched values or connect unmatched values by displaying the result in an interactive form. Example embodiment may then automatically start casting the data types to the data type and/or expected columns list 110.

### Data Preprocessing:

As shown in FIG. 6, according to example embodiments, numerous features are derived through simple or complex mathematical expressions on the historical data 124, which may be organized by cohorts. These values can be interpreted differently depending on institution context such as policy, demographics of the students, and the curriculum 120. Therefore, according to this subsystem of example embodiments, automated data pipelines are created using SQL agents 122 to detect changes, generate a list of newly added features, and provide real-time data streams for online learning modules. According to the diagram, academic and financial data 126 will be archived as historical records are received and/or updated over time. The feature engineering modules 128 produce the generated features 130.

### Online Learning Submodule:

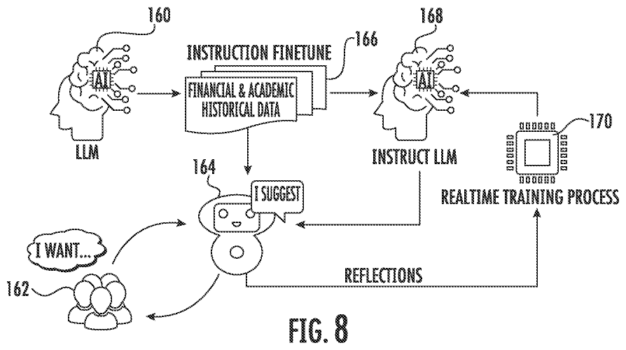

FIG. 7 illustrates an example of an online learning submodule of the machine learning module according to example embodiments. According to example embodiments, the preprocessed data are used to train machine learning models to accurately predict students' graduation outcomes. The machine learning models' predictive accuracy and recall are tested by asking the model to classify historical students and then the classification results are compared to students' true, known outcomes while trying to keep the probability of miss very low. The machine learning algorithms' predictive success is evaluated by metrics that show how reliable the model is at accurately classifying students into their graduation outcome. A high level of reliability reflects a low probability that the model will miss correctly labeling an at-risk student, as well as high classification accuracy and recall. Comparative studies of feature combinations and machine learning algorithms can determine and select the options that produce the best predictive model for a given institution. Over time though, the trained predictive model is updated with new information (incoming data 140) as the cohort data changes continuously or outcomes become available, to use together with current data 142 and past data 144. While offline or batch learning is much simpler and more straightforward for training and forming the predictive models, it requires additional complex dynamic behavior when data changes. In order to address this problem, example embodiments incorporate an online learning module that enables new feedback and outcomes to be incorporated in near real time from streams of information. The preprocessing subsystem informs the system of new data streams, and the system is able to capture and adapt to those changes regularly. Due to different unforeseeable reasons, models may need changes. For example, when institutions make changes to the data structure of their systems due to new needs or new enterprise systems data attributes. Moreover, different institutions may require different models based on engineered features. Therefore, model monitoring needs to be an ongoing process to ensure the model never deteriorates and performs consistently. Sometimes restructuring the models may be necessary in order to accommodate the constantly changing dataset. Therefore, an online learning algorithm capable of selecting the optimal machine learning model for training new data is proposed through comparative analysis of different model's performance. After initial batch training for creating a predictive model, the online learning service intelligently selects the most suitable algorithm or model, via model selection 150 for training new data and incorporating the scientists' insights. The data processing module 146 processes the data and enables the online learning service to perform automatic training 152, label prediction 154, and label revision 156, to further enable selection of a model 158 such as but not limited to random forest, logistic regression, support vector machines (SVM) and/or the like. The online machine learning processes operate to generate one or more metrics 159, such as but not limited to advisor-facing metrics and/or student-facing metrics, described in further detail herein.

Example embodiments reflect reliable system features for both the machine learning side and the overall system performance. The machine learning features include batch and online machine learning, creating multiple data and predictive models through comparative studies of features and algorithms, providing metrics to measure the reliability defined by low probability of missing at-risk students and high overall accuracy and recall. The aforementioned system features are supported by innovative architectural design that promotes consistent system performance under scaling and multiple users. Another reliability factor of example embodiment includes the secure and flexible integration as a cloud-based solution or a combination of local and cloud-services into existing higher education institution's complex enterprise system infrastructure.

Once potentially at-risk students are identified by the machine learning algorithms, the system will include tools for institutions to use in their interventions with students. Using the system's dynamic course & financial planning interface (described in further detail herein), students are assigned to plan their courses for the upcoming semesters considering their financial circumstances and submit their plan to their advisors for verification. The intelligent conversational agent aims to bridge the gap between students' academic aspirations and their financial realities, offering real-time and on-demand guidance to students as they undertake this planning intervention exercise to ensure they make well-informed decisions. Furthermore, advisors receive stories and insight about students and their plans in clear English built by the large language models. This provides advisors with the tools they need to offer effective guidance.

As illustrated in FIG. 8, the intelligent conversational agent module centers around the utilization of Large Language Models (LLMs) to facilitate seamless interactions between student-users and advisor-users 162, and the system. These LLMs are a subset of machine learning in the domain of Natural Language Processing (NLP), which underpins the ability of the system to understand, process, and generate human language in a meaningful way. One notable LLM is OpenAI's GPT-3, which has demonstrated a capacity for deep contextual understanding and language generation. The application of LLMs in this module enables the creation of a sophisticated chatbot 164 capable of providing on-demand guidance to students as they plan their academic courses, considering their financial situations. These models can understand complex queries, provide detailed responses, and even suggest actions based on the data at hand. Furthermore, they can translate the academic and financial data into clear, insightful narratives that help advisors in understanding the students' situations and in making informed decisions.

The utility of LLMs extends to interpreting and generating narratives from a vast array of academic and financial data, making the conversations with the chatbot informative and actionable. Moreover, the LLMs can be fine-tuned (166) to adhere to the specific terminologies and compliance requirements prevalent in the higher education domain, ensuring that the generated responses and narratives are precise and relevant.

Additionally, the module can be enhanced with continuous learning mechanisms, allowing the chatbot to evolve with every interaction and stay updated with the latest policies, financial aid structures, and academic requirements. This is crucial for maintaining the accuracy and relevance of the guidance provided to the students and advisors.

Continuous fine tuning of LLMs through online learning may instruct the LLMs (168) include, among other features, a real-time training process 170, privacy preserving, online learning framework integration, a user feedback loop, incremental fine-tuning mechanism, real-time performance monitoring, domain-specific adaptation, and/or the like.

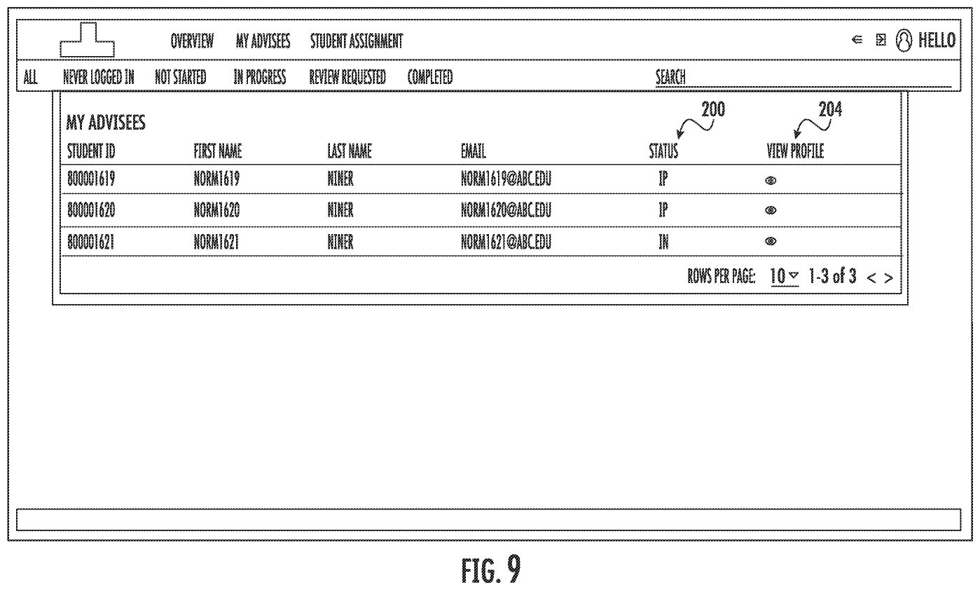

FIGS. 9-15, 16A-16G, 17, and 18 show example user interface displays provided according to example embodiments. The displays are provided by one or more of a student-facing user interface, advisor-facing user interface, and/or administrator-facing user interface. An administrator-user may have additional security and/or functionality available to them in comparison to an advisor-user (who may, for example, lean toward viewing reports with advisor-facing metrics, etc., configuring basic report parameters, and/or the like, whereas an administrator-user may perform more advanced configuration such as editing data mappings, selecting different machine learning models, and/or the like). Any variation or balancing of user-type functionality may be contemplated. It will therefore be appreciated that although some displays are described as provided by student-facing user interfaces, advisor-facing user interfaces, and/or administrator-facing user interfaces to describe a primary use case, for example, some of the displays or portions thereof may additionally be accessed by another user type, such that descriptions are not intended to be limiting. Similarly, advisor-facing metrics may encompass metrics primarily intended for an advisor-user whereas student-facing metrics may primarily be intended for a student-user, but in certain embodiments, some metrics may be provided to either or both user-types, and any variations and configurations may be contemplated.

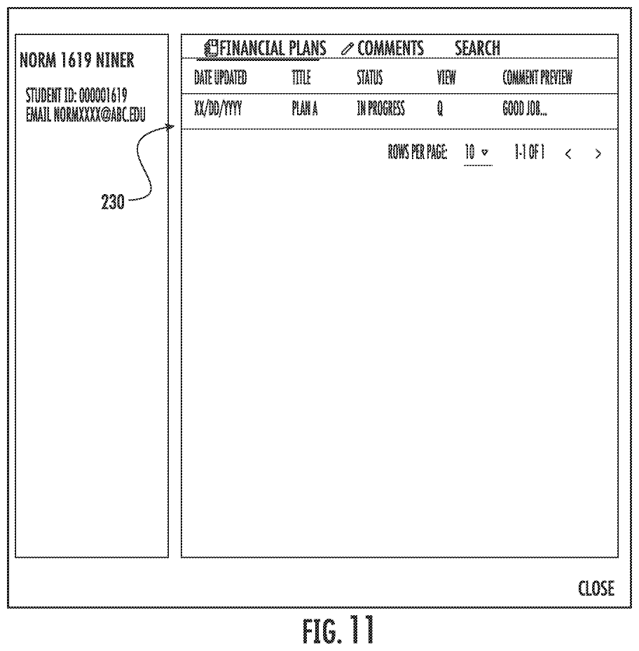

FIG. 9 is an example display of an advisor-facing user interface. An advisor-user can access the user interface to view a list of advisees and respective personal information, and one or more advisor-facing metrics relating to student progress. For example, the view may include a status 200 for each student with regard to completing a plan (e.g., student-specific academic plan progress status), according to example embodiments. According to certain embodiments, the view may include an indicator of student progress, such as a predicted student success indicator (not shown in FIG. 9) generated using the trained model. The predicted student success indicator may further indicate a two-tier hierarchical predictor indicating whether or not a student is predicted to graduate, and if so, whether the student will graduate within a predetermined time period, as also predicted using the trained model. As another example, the view of FIG. 9 may be filtered to display only the students identified as ‘at-risk,’ such as based on a configurable threshold of a predicted student success indicator. In this regard, a predicted student success indicator may be a quantifiable amount, and a threshold may be configured such that student data having an associated indicator with a predefined relationship (e.g., less than, less than or equal to, greater than, greater than or equal to) the threshold are displayed in a view of the advisor-facing user interface. The advisor-user can further select an indicator 204 to view a respective student's profile. For example, upon selection, the view may transition to that of FIG. 11, described in further detail below. The information viewable in a student's profile may vary according to certain configurations, such as whether or not a student has enabled or configured an advisor-user access to view financial plans or details.

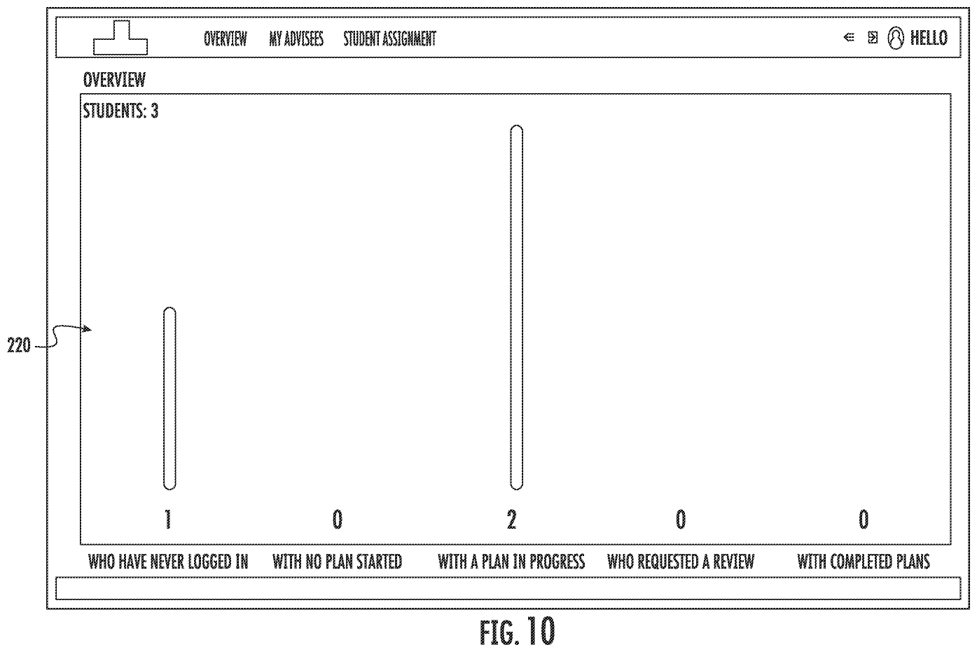

FIG. 10 is an example display of an advisor-facing user interface according to example embodiments. An advisor-user can view a breakdown of student statuses 220 with respect to having accessed or not accessing the system, having no plan started, having a plan in progress, having requested a review by the advisor, and having a completed plan. A respective bar may be selectable according to certain example embodiments to enable the advisor-user to view students falling into a respective category, such as in a respective list type view such as that of FIG. 9.

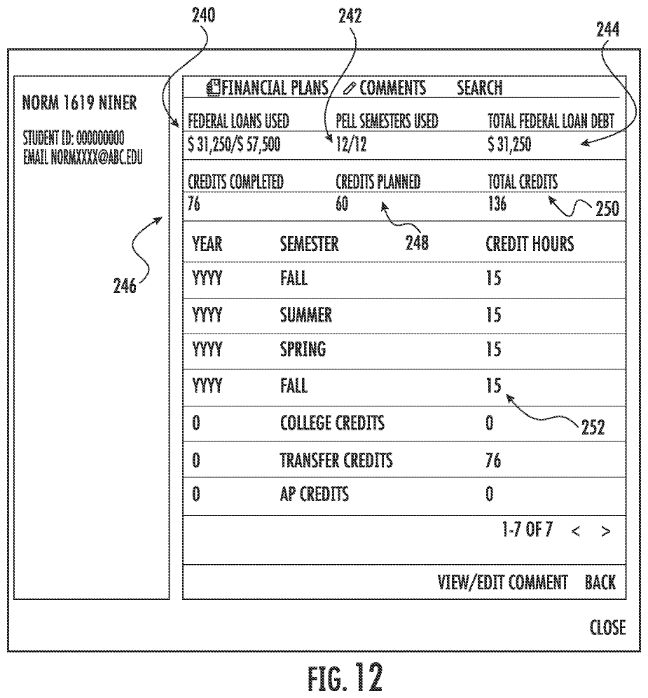

FIG. 11 is another example display of an advisor-facing user interface that may be provided according to example embodiments. A list of financial plans 230, such as alternative financial plans, which have been created and/or modified by a student-user and/or advisor-user (such as by collaboration), may be provided along with date modified, title plan, plan status, selectable icon to view details, and a comment preview. Upon selection of a selectable icon to view details, the view may transition to that of FIG. 12.

FIG. 12 is another example display of an advisor-facing user interface according to example embodiments, providing a detailed plan view. The detailed plan view may include a total amount of federal loans used out of a remaining amount allowed (240), Pell semesters used (242), and total federal loan debt (244). In certain embodiments, the financial information (such as 240, 242 and/or 244) may only be displayed via an advisor-facing user interface if a student authorizes such information to be shared with their advisor. In this regard, example embodiments, via a student-facing user interface, enable a student-user to authorize an advisor-user to access the subject student-related financial data. The detailed plan view according to example embodiments may further include credits completed 246, credits planned, and total credits 250. The detailed plan view may further include a list of credits by semester, institution credits, transfer credits, advanced placement (AP) credits, and/or the like (252).

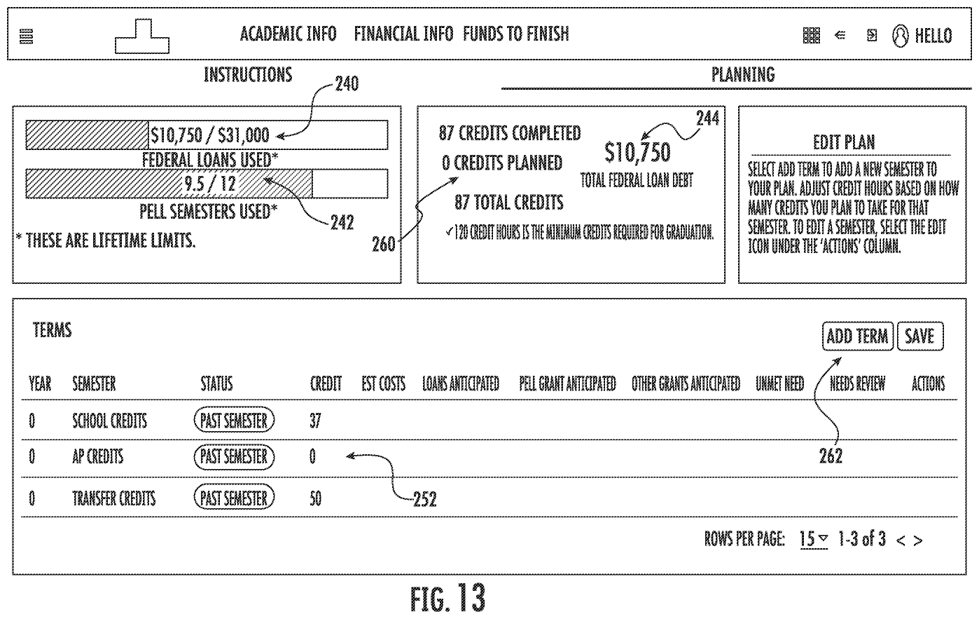

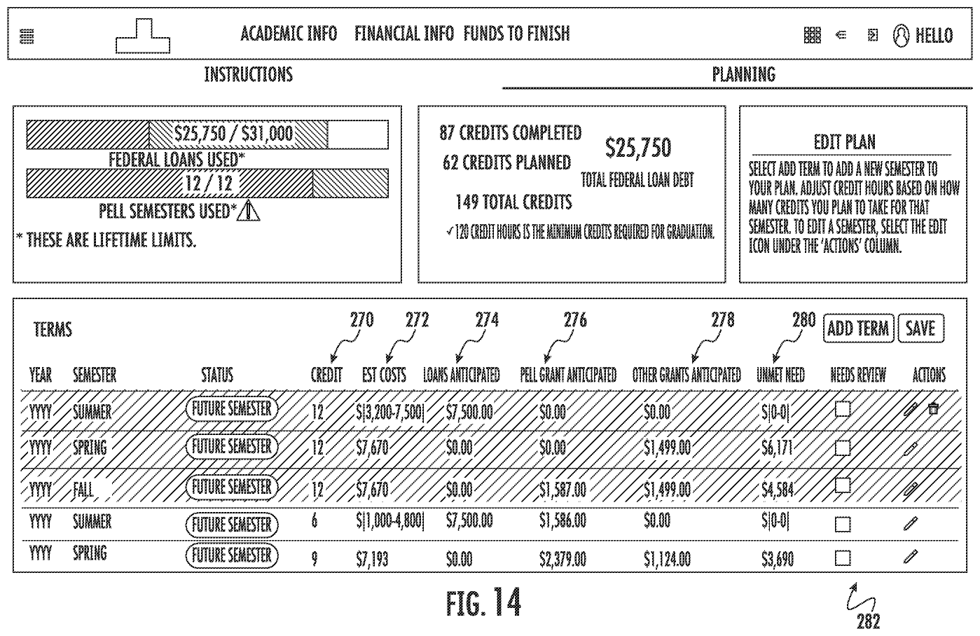

FIGS. 13 and 14 are example displays of a student-facing user interface that enable a student-user to configure a student-specific academic plan. In certain scenarios such as those in which a student-user has authorized an advisor to access their financial records, the display of FIG. 13 may be additionally provided via an advisor-facing user interface and may include some information also provided in the display of FIG. 12. The example displays includes a remaining amount allowed (240), Pell semesters used (242), total federal loan debt (244), as well as the number of credits completed, planned, and total credits (260), and a list of credits by semester, institution credits, transfer credits, advanced placement (AP) credits, and/or the like (252). A user can utilize the ‘add term’ button 262 to work on plan details for a specific term, such as to add planned coursework, move certain courses from one term to another, add an additional term such as a summer term, and/or the like.

FIG. 14 is an example view of a student-facing user interface according to example embodiments. In certain scenarios such as those in which a student-user has authorized an advisor to access their financial records, the view of FIG. 14 may be additionally provided via an advisor-facing user interface. The view shows a per-term listing of credits (270), estimated costs (272), loan amounts anticipated (274), an amount of Pell grant funds anticipated (276), amounts of other grants anticipated (278) and an estimate of unmet need (280). Any of the displayed financial data may be imported from the institution's financial systems, and/or manually provided by a user. A user may indicate a request (282) for an advisor to review a semester plan.

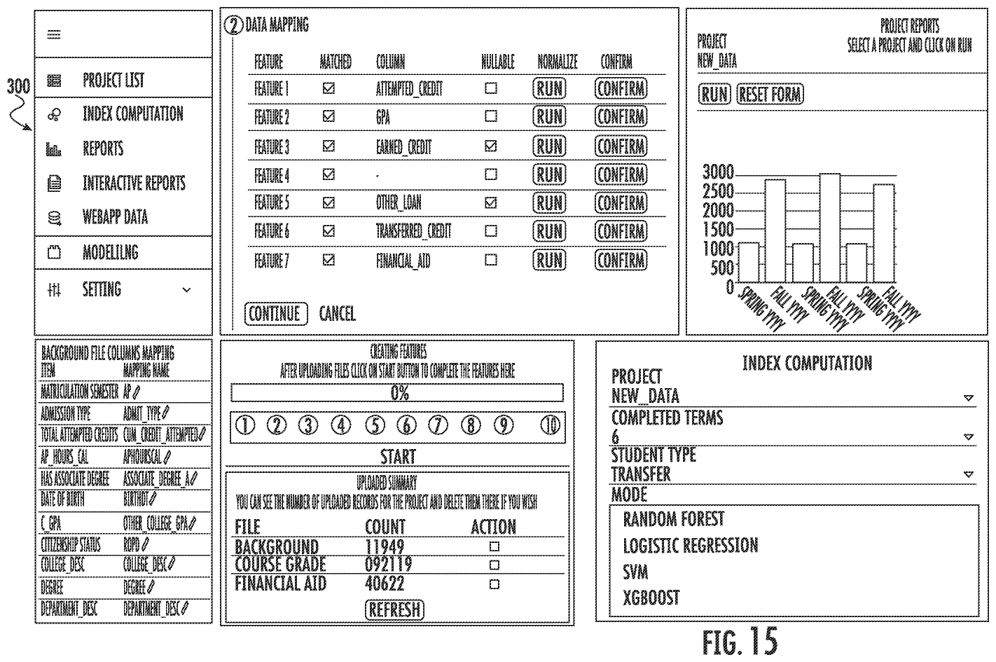

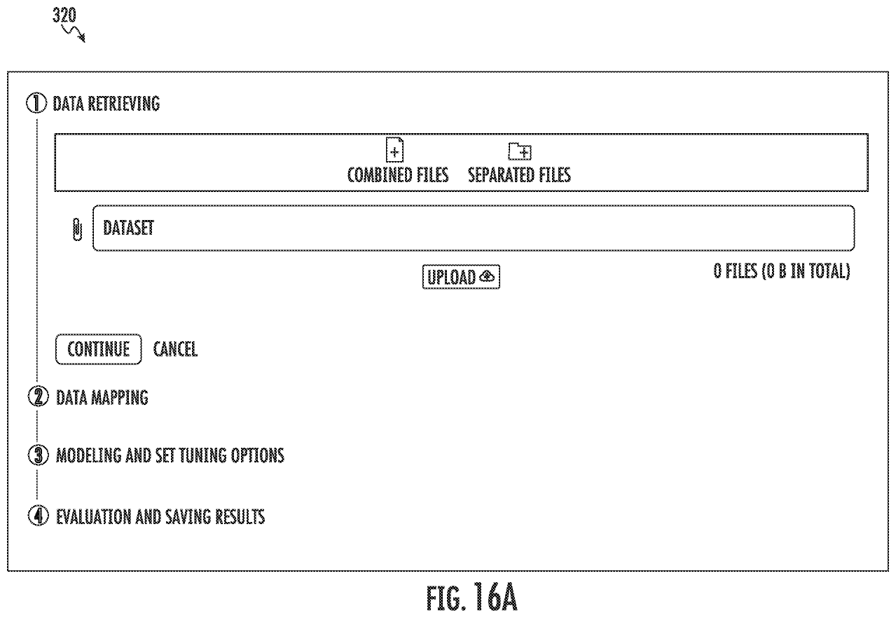

FIG. 15 is an example display of an administrator-facing user interface provided according to certain example embodiments. The administrator-facing user interface provides configuration information relating to the training of the model, and further enables (a) configuration of data used by the model, and (b) finetuning of parameters used by the model. The administrator-facing user interface enables configuration of the system on a per-institution basis to facilitate portability, and compatibility across different institutions and their respective systems. The example interface of FIG. 15 provides snapshots of certain displays of an administrator-facing user interface provided in a configurable arrangement. An administrator-user may access various administrator-facing user interfaces via menu 300. Detailed views of the various displays are described in further detail below.

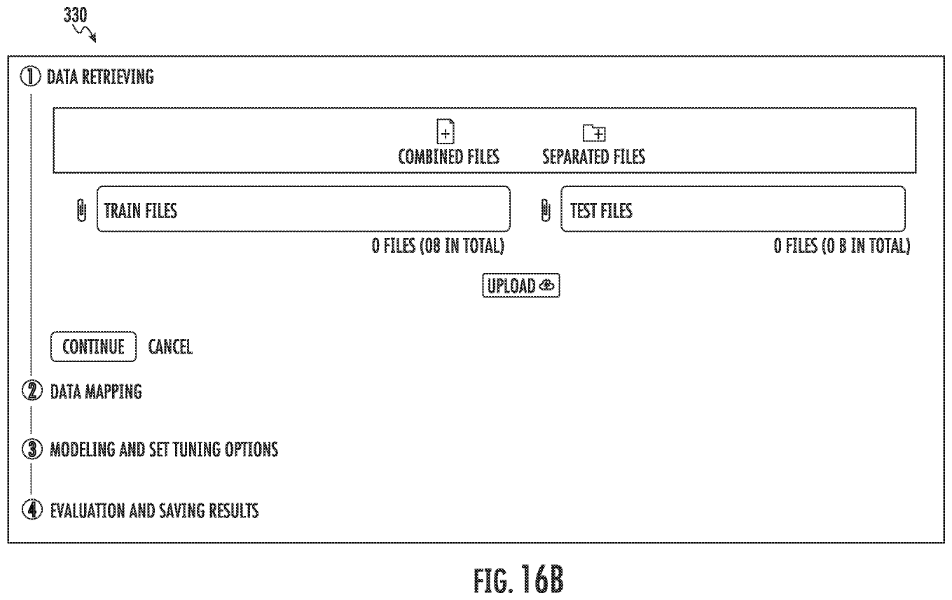

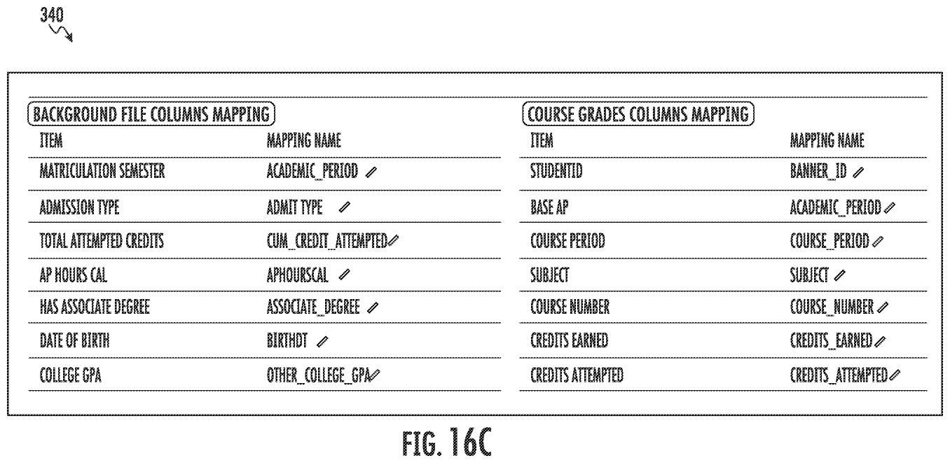

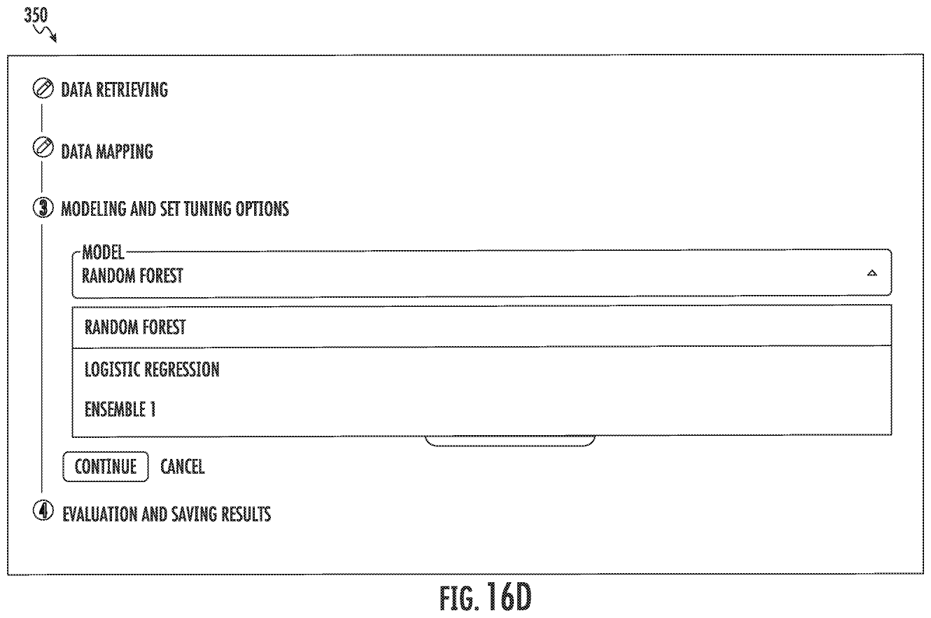

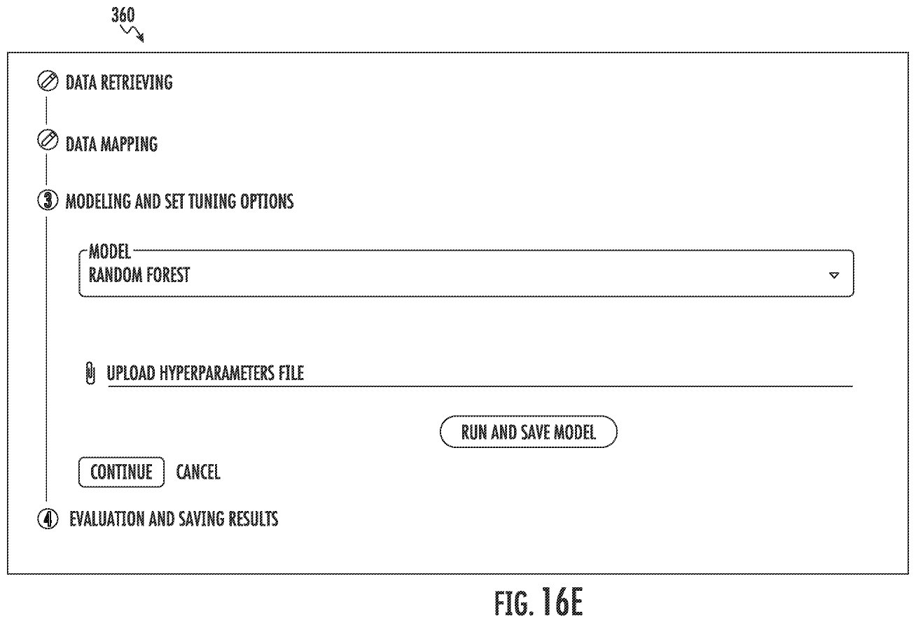

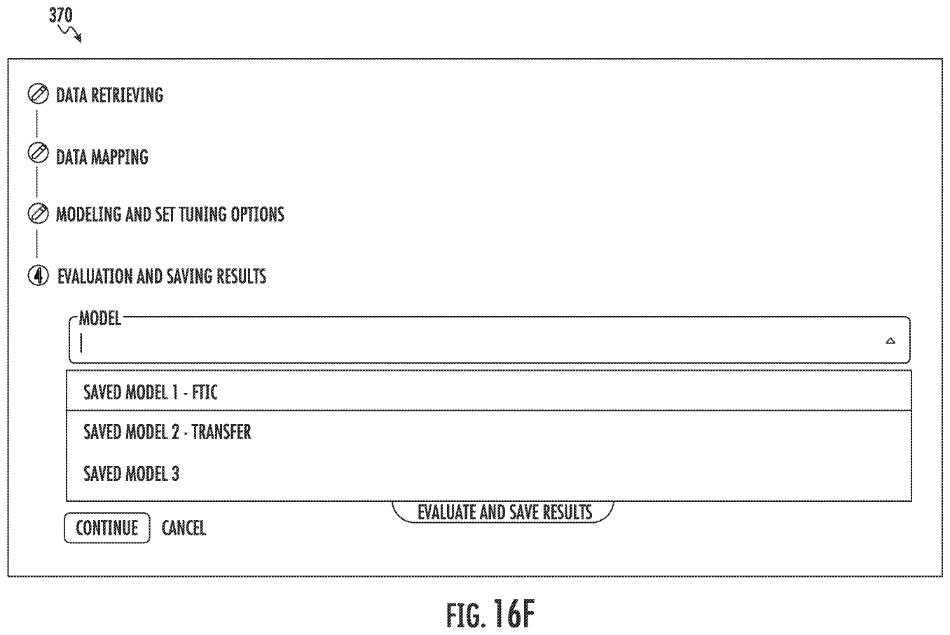

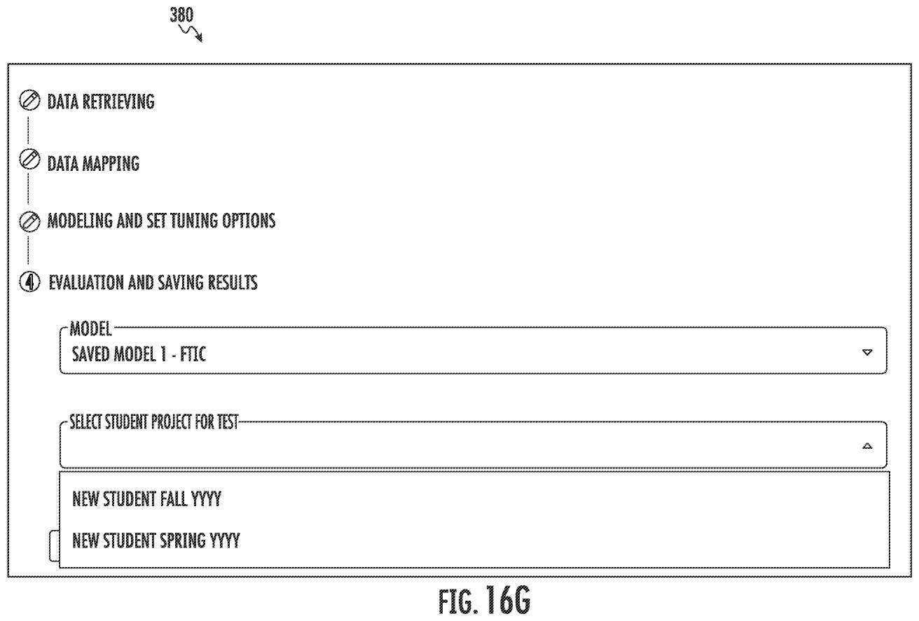

As shown in FIG. 16A, the administrator-facing user interface enables an administrator-user to upload files containing data via a display 320 of the administrator-facing user interface. Additionally or alternatively, an administrator-user can enter a file location of the data file (not shown) to upload the entire data set which includes training data and the test data. This is a critical step for users (data scientists) to be able to build models from one complete data set and run multiple tests to make sure the model is working properly. It is important to notice that the student data may be in a plurality of datafiles that have different data items in columns and students in rows and the modeling cannot work properly without having a consistent and uniform dataset.

FIG. 16B includes a variation of FIG. 16A, and is an example administrator-facing user interface display 330 that enables uploading of separated files for the training data and test data. When multiple years of data are used for training the model, the data set would be very large. Data scientists need to make sure the data is consistent and does not include any discrepancy or incompleteness before running the training and building the data model. Furthermore, after the model is built, the scientist can upload test data for testing the model. This provides a major feature which is very necessary in building models which have high accuracy and very low error type II.

The contents of the file(s) may be processed by a processor of example embodiments, and the fields mapped to data fields preconfigured within the system for training the model and/or utilizing the model to generate one or more advisor-facing metrics relating to student progress. Example embodiments may utilize natural language processing to map data fields having the same underlying value type despite different naming conventions. Institutional names for data pieces can vary for a number of reasons (names change over time, or student data is named or formatted differently: e.g., ‘cumulative_GPA’/‘cumulativeGPA’/‘cumulative_gpa’). Example embodiments further enable an administrator-user to review data mappings generated by example embodiments, such as with natural language processing, to modify or confirm the data mappings. As shown FIG. 16C, the administrator-user can review and/or edit which data field names map to different items in the application's code, via a display 340 of the administrator-facing user interface. The interface allows the user to map the data field names their institution use to what the program code calls a given data element. See also the system diagram of FIG. 5 and its components.

According to certain embodiments, and as shown in FIG. 16D, a display 350 of the administrator-facing user interface enables an administrator-user to configure modeling and tuning options. For example, the user can specify an algorithm (e.g., random forest, logistic regression, etc.). Accordingly, at least partial user-control of some of the processes in FIG. 7 may be enabled, although example embodiments further facilitate the automatic training 152 and continuous updates to the model as described in further detail herein.

As shown in FIG. 16E, a display 360 of the administrator-facing user interface enables a user to complete the training and building the model by choosing the one of several available algorithms and further uploading the corresponding hyperparameters file. Once the model is built, the user is able to save the model. Display 370 of FIG. 16F enables the user to save and name the model and display 380 of FIG. 16F enables the user to save the model to a project.

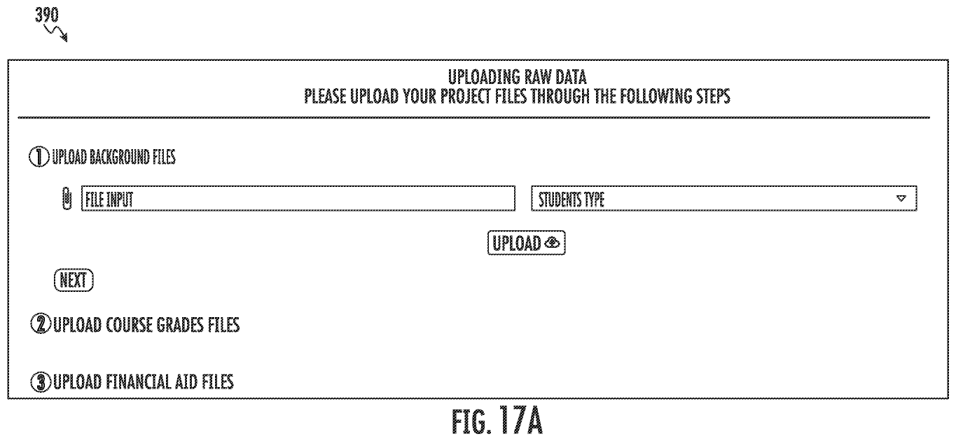

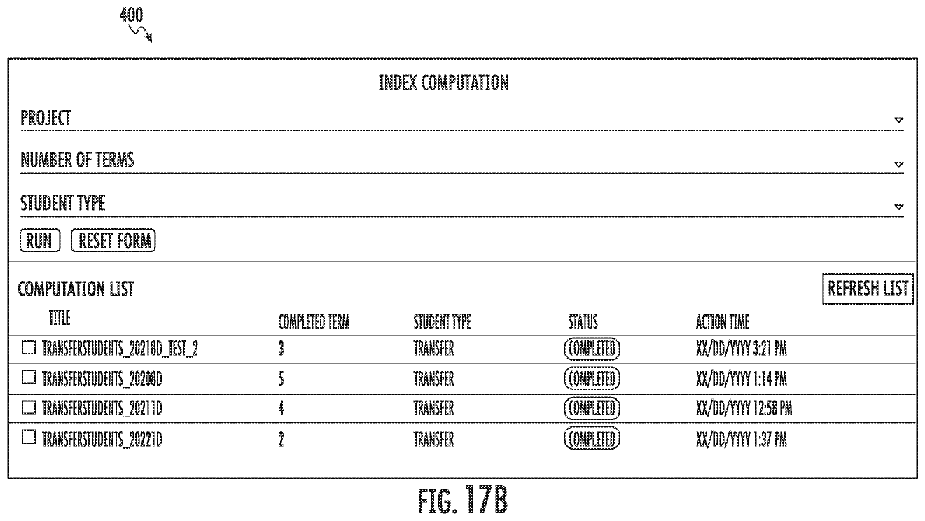

As shown in FIG. 17A, a display 390 of the administrator-facing user interface enables a user to upload data, such as .csv files, containing information on students (background info including students' admissions information and demographics, course grades, financial aid data). Additionally or alternatively, file locations may be submitted to enable continuous updating and/or monitoring of data. The data files are ingested according to the configurations and projects and the features (variables) for the machine learning model are created. The data and features are associated with one or more configured projects.

As shown in FIG. 17B, with display 400, the user selects a project, specifies how many academic terms of information the model should use, and specifies if a first-time-in-college or transfer student model should be applied. The machine learning model processes the data with the additionally configured parameters and results are displayed in a computation list. An advisor-user and/or administrator-user can then access one or more advisor-facing metrics in various ways.

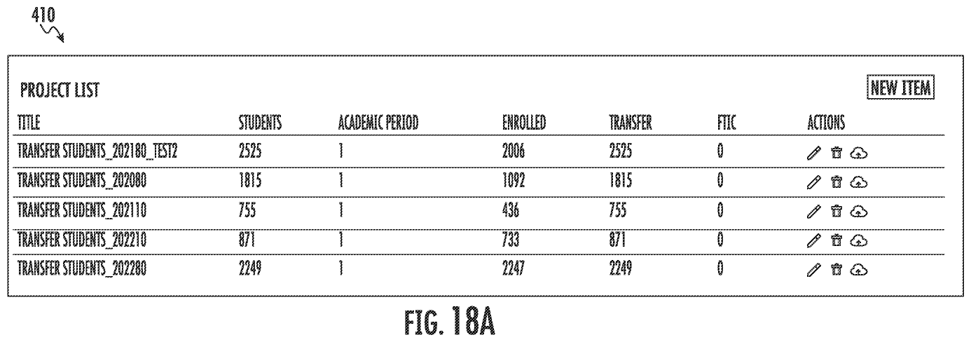

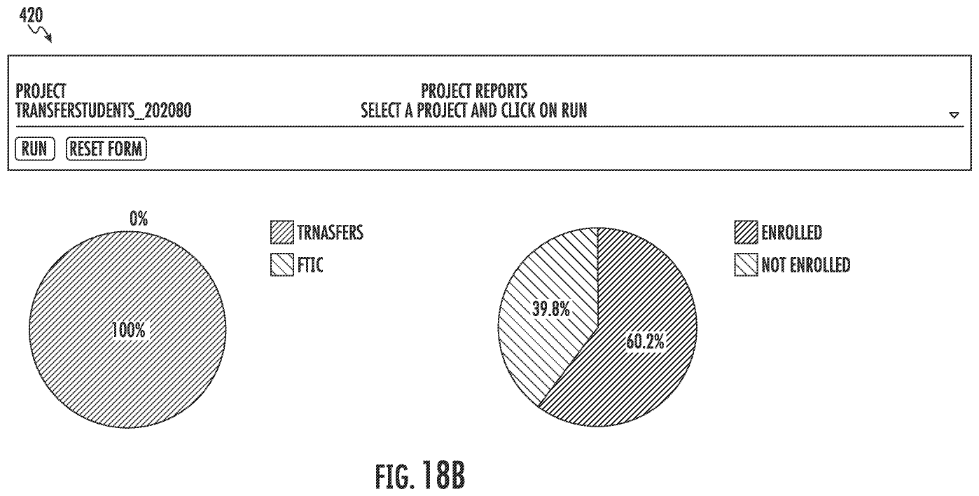

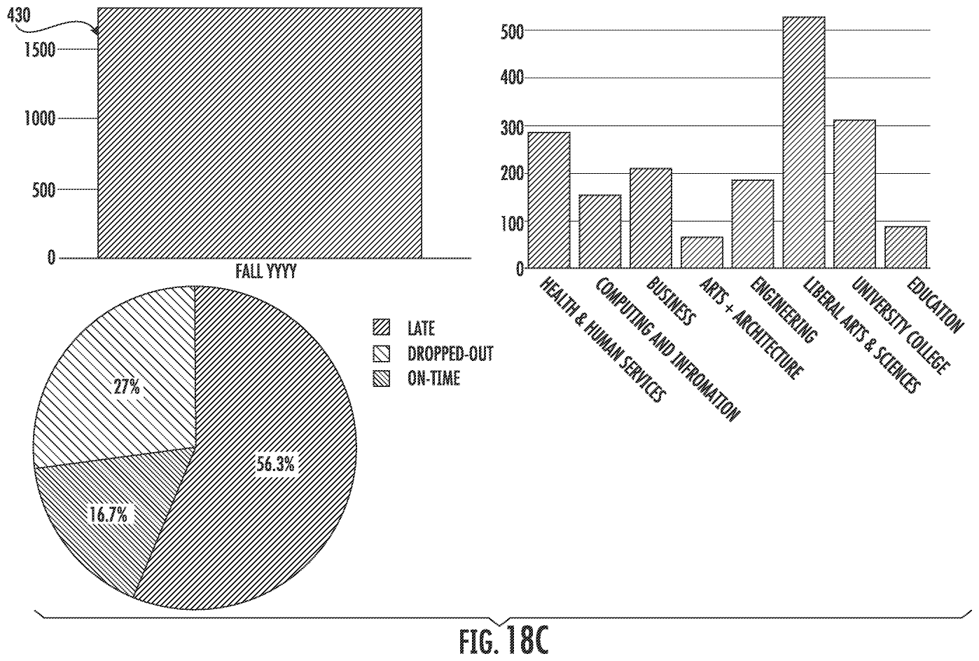

As shown in display 410 of FIG. 18A, the advisor-user and/or administrator-user can download a .csv file containing the output of the machine learning model. This may include the students' name and contact info, relevant student information (e.g., major, advisor), a graduation outcome classification for each student, a predicted student success indicator and/or other statistics related to the model classification results.

Displays 420 and 430 of FIGS. 18B and 18C provides sample reports that may be accessed by an advisor-user and/or administrator-user. The report area may include an initial list of default or pre-configured reports. Using the reports, an advisor-user and/or administrator-user can then access one or more reports to view one or more advisor-facing metrics.

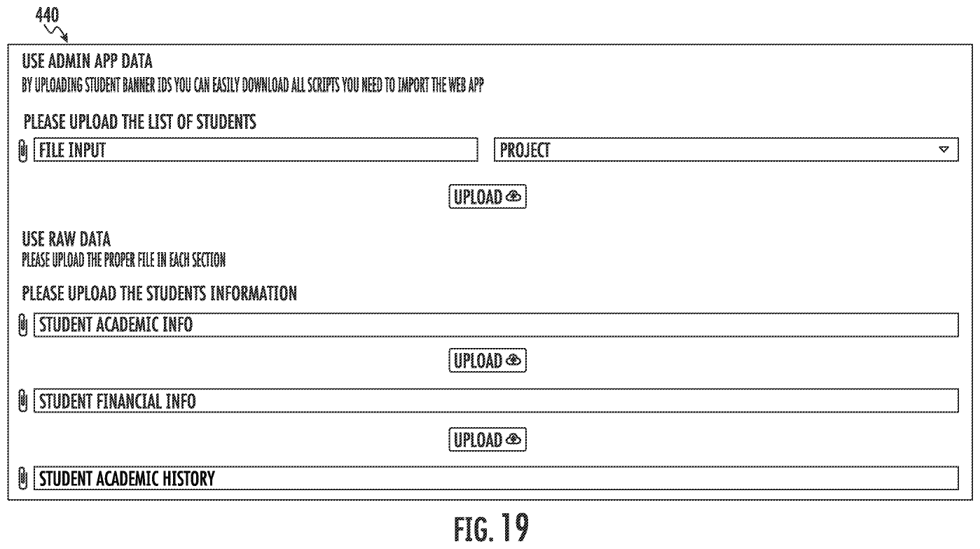

Display 440 of FIG. 19 enables an administrator-user and/or advisor-user to specify a list of students from a contained entity that is called “project” to send to the student-facing user interface. Additionally, or alternatively, the advisor-user and/or administrator-user can upload raw data with student information to enable access by student-users. Additionally or alternatively, if a user doesn't want to run the machine learning functionality for certain students or at all, but does want students to use the student-facing user interface, student data can be uploaded to enable student-user access to the student-facing user interface so that students can still use the software to plan their courses considering their financial circumstances.

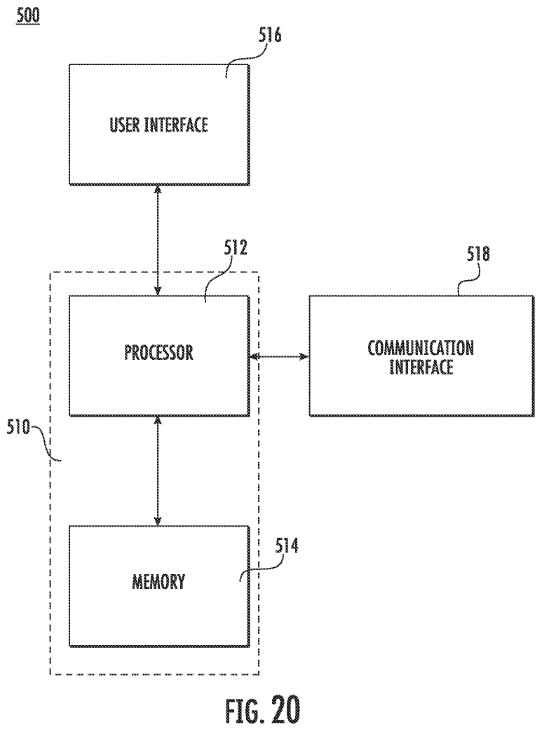

Referring now to FIG. 20, apparatus 500 is a computing device(s) configured for implementing any of the components of the system(s) described herein, such as any of the apparatuses or systems that implement the systems of FIGS. 1-8. Apparatus 500 may at least partially or wholly embody or be embodied by any of the components of FIGS. 1-8. Apparatus 500 may therefore implement any of the components therein, in accordance with some example embodiments, or may be implemented as a distributed system that includes any combination of the components, and/or associated network(s).

It should be noted that the components, devices, and elements illustrated in and described with respect to FIG. 20 may not be mandatory and thus some may be omitted in certain embodiments. For example, FIG. 20 illustrates a user interface 516, as described in more detail below, which may be optional in certain devices, such as servers configured to perform certain data processing methods, machine learning process, and/or the like. Additionally, some embodiments may include further or different components, devices, or elements beyond those illustrated in and described with respect to FIG. 5.

Continuing with FIG. 20, processing circuitry 510 may be configured to perform actions in accordance with one or more example embodiments disclosed herein. In this regard, the processing circuitry 510 may be configured to perform and/or control performance of one or more functionalities of apparatus 500 in accordance with various example embodiments. The processing circuitry 510 may be configured to perform data processing, application execution, and/or other processing and management services according to one or more example embodiments. In some embodiments apparatus 500, or a portion(s) or component(s) thereof, such as the processing circuitry 510, may be embodied as or comprise a circuit chip. The circuit chip may constitute means for performing one or more operations for providing the functionalities described herein.

In some example embodiments, the processing circuitry 510 may include a processor 512, and in some embodiments, such as that illustrated in FIG. 5, may further include memory 514. The processing circuitry 510 may be in communication with or otherwise control a user interface 516, and/or a communication interface 518. As such, the processing circuitry 510, such as that included in any of the service provider system 106, and/or other apparatus 500 may be embodied as a circuit chip (e.g., an integrated circuit chip) configured (e.g., with hardware, software, or a combination of hardware and software) to perform operations described herein.

The processor 512 may be embodied in a number of different ways. For example, the processor 512 may be embodied as various processing means such as one or more of a microprocessor or other processing element, a coprocessor, a controller, or various other computing or processing devices including integrated circuits such as, for example, an ASIC (application specific integrated circuit), an FPGA (field programmable gate array), or the like. Although illustrated as a single processor, it will be appreciated that the processor 512 may comprise a plurality of processors. The plurality of processors may be in operative communication with each other and may be collectively configured to perform one or more functionalities of apparatus 500 as described herein. The plurality of processors may be embodied on a single computing device or distributed across a plurality of computing devices collectively configured to function as apparatus 500. In some example embodiments, the processor 512 may be configured to execute instructions stored in the memory 514 or otherwise accessible to the processor 512. As such, whether configured by hardware or by a combination of hardware and software, the processor 512 may represent an entity (e.g., physically embodied in circuitry—in the form of processing circuitry 510) capable of performing operations according to embodiments of the present invention while configured accordingly. Thus, for example, when the processor 512 is embodied as an ASIC, FPGA, or the like, the processor 512 may be specifically configured hardware for conducting the operations described herein. Alternatively, as another example, when the processor 512 is embodied as an executor of software instructions, the instructions may specifically configure the processor 512 to perform one or more operations described herein.

In some example embodiments, the memory 514 may include one or more non-transitory memory devices such as, for example, volatile and/or non-volatile memory that may be either fixed or removable. In this regard, the memory 514 may comprise a non-transitory computer-readable storage medium. It will be appreciated that while the memory 514 is illustrated as a single memory, the memory 514 may comprise a plurality of memories. The plurality of memories may be embodied on a single computing device or may be distributed across a plurality of computing devices. The memory 514 may be configured to store information, data, applications, computer program code, instructions and/or the like for enabling apparatus 500 to carry out various functions in accordance with one or more example embodiments. For example, memory 514 may be configured to store computer program code for performing corresponding functions thereof, as described herein according to example embodiments.

Still further, memory 514 may further include a database. The memory 514 may be further configured to buffer input data for processing by the processor 512. Additionally or alternatively, the memory 514 may be configured to store instructions for execution by the processor 512. In some embodiments, the memory 514 may include one or more databases that may store a variety of files, content, or data sets. Among the contents of the memory 514, applications may be stored for execution by the processor 512 to carry out the functionality associated with each respective application. In some cases, the memory 514 may be in communication with one or more of the processor 512, user interface 516, and/or communication interface 518, for passing information among components of apparatus 500.

The optional user interface 516 may be in communication with the processing circuitry 510 to receive an indication of a user input at the user interface 516 and/or to provide an audible, visual, mechanical, or other output to the user. As such, the user interface 516 may include, for example, a keyboard, a mouse, a display, a touch screen display, a microphone, a speaker, and/or other input/output mechanisms. As such, in embodiments, in some example embodiments, provide means for user entry of configurations, user access to certain metrics described herein, and/or the like. The user interface 516 may be further configured to display the example displays of the student-facing user interface, advisor-facing user interface, and/or administrator-user interface provided herein. In some example embodiments, aspects of user interface 516 may be limited or the user interface 516 may not be present.

The communication interface 518 may include one or more interface mechanisms for enabling communication with other devices and/or networks. In some cases, the communication interface 518 may be any means such as a device or circuitry embodied in either hardware, or a combination of hardware and software that is configured to receive and/or transmit data from/to a network and/or any other device or module in communication with the processing circuitry 510. By way of example, the communication interface 518 may be configured to enable communication over a network, amongst any of the components of the system(s) described herein, including various instances of apparatus 500. Accordingly, the communication interface 518 may, for example, include supporting hardware and/or software for enabling wireless and/or wireline communications via cable, digital subscriber line (DSL), universal serial bus (USB), Ethernet, or other methods.

A network, such as the network in which the disclosed system(s) or components thereof or components described herein may operate, may include a local area network, the Internet, any other form of a network, or any combination thereof, including proprietary private and semi-private networks and public networks. The network may comprise a wired network and/or a wireless network (e.g., a cellular network, wireless local area network, wireless wide area network, some combination thereof, and/or the like).

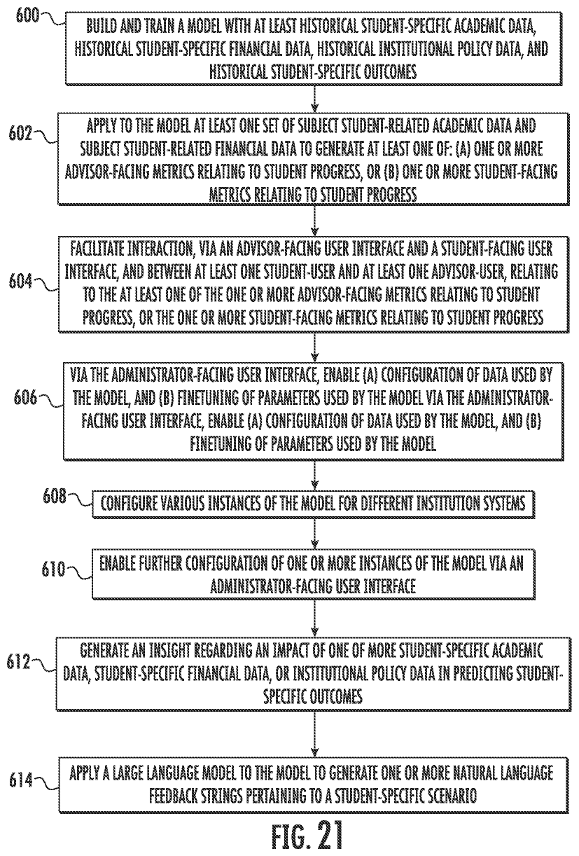

Having now described the apparatus 500 that implements components of the disclosed apparatuses and/or systems, FIG. 21 is a flowchart of operations that may be performed by apparatus 500, according to certain embodiments.

As shown by operation 600, the service provider system 106, such as apparatus 500, includes means, such as processor 512, memory 514, communication interface 518, and/or the like, for building and training a model with at least historical student-specific academic data, historical student-specific financial data, historical institutional policy data, and historical student-specific outcomes. It will be further appreciated that any other student demographic data and/or the like may be incorporated into the model (e.g., distance from home, etc.).

Example embodiments utilize historical data imported from various sources. The historical student-specific academic data, historical student-specific financial data, historical institutional policy data, and historical student-specific outcomes may be provided from disparate systems, some of which may operate independently of one another, and/or may be in different configurations that vary from one institution to another. Historical student-specific academic data may include cumulative GPA, number of semesters enrolled, cumulative credits earned, etc. Historical student-specific financial data may include Pell Grant semesters remaining, total loan amounts, etc. It will be appreciated that despite including the authorization feature in which a student can authorize their academic advisor to access financial data (see for example FIG. 12), example embodiments utilize historical student-specific financial data in its machine learning model along with their academic data and background, such as via backend secure processes, that integrate financial data into the model without directly exposing the financial data to academic advisors without authorization.

Historical institutional policy data may include credits required, curriculum requirements for certain degrees, and/or the like. Examples of certain types of historical data that have been identified as being accurate predictors of student outcomes according to an exemplary study and using example embodiments (not intended to be limiting) include the examples in Table 1, with their respective frequencies of measure, and range of importance of student data using a selected machine learning algorithm type.

TABLE 1
Features of greatest importance for predicting graduation
outcomes according to one exemplary study.

| | | Range of | |
|---|---|---|---|
| | | importance | |
| Feature | Frequency | Min | Max |
| Cumulative credits earned | Term | 0.059 | 0.132 |
| Cumulative GPA | Term | 0.041 | 0.115 |
| Satisfactory academic progress | Annual | 0.001 | 0.106 |
| standing | | | |
| Completion index | Term | 0.012 | 0.105 |
| Cumulative credits attempted | Term | 0.031 | 0.087 |
| Count of stop-out terms | Term | 0.000 | 0.075 |
| Cumulative federal aid awarded | Term | 0.011 | 0.067 |
| per credits earned | | | |
| Change in cumulative GPA from | Term | 0.000 | 0.059 |
| term to term | | | |
| High school GPA | At admissions | 0.012 | 0.059 |
| Distance from home | At admissions | 0.011 | 0.059 |
| Estimated family contribution | Annual | 0.009 | 0.054 |
| Composite ACT/SAT standardized | At admissions | 0.011 | 0.050 |
| score | | | |
| Overall federal financial aid | Annual | 0.014 | 0.041 |
| awarded | | | |
| Cumulative measure of course | Term | 0.006 | 0.040 |
| lateness in critical progression | | | |
| courses | | | |
| Cumulative GPA in critical | Term | 0.013 | 0.040 |
| progression courses | | | |
| Earned credit hours at admissions | At admissions | 0.005 | 0.039 |
| Count of courses taken in unique | Term | 0.012 | 0.030 |
| programs | | | |
| Change in credits earned term | Term | 0.005 | 0.028 |
| to term | | | |
| Count of unique critical | Term | 0.012 | 0.028 |
| progression courses passed | | | |
| Cumulative count of critical | Term | 0.005 | 0.025 |
| progression courses taken late | | | |
| Count of C, D, F, or W grades | Term | 0.007 | 0.022 |
| in critical progression courses | | | |

The breadth of data points used, variety of sources from which the data originates, frequency measured, and varying ranges of importance emphasizes the improvements to related technology provided by example embodiments, in comparison to prior systems, based on the usage of a machine learning model(s), in predicting student success indicators. The breadth of data points used, variety of sources from which the data originates, frequency measured, and varying ranges of importance further emphasize the impracticality of attempting to perform such analysis by traditional or human-implemented methods. For example, the importance of certain features compared to others could vary between institutions, demographics, degree types, etc.

The historical student-specific outcomes used to build and train the model may include a variety of labels of real outcomes associated with the historical data, such as but not limited to graduation data, dropout indicators, graduation within a certain time period (e.g., 4 years), failure to graduate within the certain time period, grades, GPA, and/or the like. The data provided with respect to operation 600 may be provided via one or more displays of an advisor-facing user interface and/or administrator-facing user interface such as provided in FIGS. 16A-16G and/or the like. The data provided with respect to operation 600 may be used to build and train the online machine learning model (which may be referred to herein as an online machine learning model, and/or more simply, a ‘model’) such as with the systems depicted in FIGS. 1-8 and their respective components (e.g., apparatus 500).

As shown by operation 602, the service provider system 106, such as apparatus 500, includes means, such as processor 512, memory 514, communication interface 518, and/or the like, for applying to the model at least one set of subject student-related academic data and subject student-related financial data to generate at least one of: (a) one or more advisor-facing metrics relating to student progress, or (b) one or more student-facing metrics relating to student progress. In this regard, example embodiments access the model trained with at least historical student-specific academic data, historical student-specific financial data, historical institutional policy data, and historical student-specific outcomes (e.g., the model built and trained with respect to operation 600). Example embodiments apply data pertaining to a subject student (e.g., all students enrolled at an institution, those indicated via an administrator-facing user interface and/or the like). The subject student-related academic data and subject student-related financial data may be provided via one or more displays of an administrator-facing user interface such as provided in FIG. 17A and/or the like. The student-related academic data and/or subject student-related financial data may include any data fields such as those of Table 1, for example. Example student-related academic data may include cumulative GPA, number of semesters enrolled, cumulative credits earned, etc. Example student-related financial data may include data pertaining to any resources such as but not limited to scholarships (e.g., Pell Grants), loans, etc.

The (a) one or more advisor-facing metrics relating to student progress and/or (b) one or more student-facing metrics relating to student progress may include a variety of outputs such as metrics displayed in or accessible via example displays of FIGS. 9-15, 18A-18C, and/or the like. For example, student-facing metrics relating to student progress may include a financial estimate pertaining to completion of a degree, estimated number of remaining semesters needed to complete a degree, etc., and may update as a student modifies their plan(s). Advisor-facing metrics relating to student progress may include indicate at least one of a student-specific academic plan progress status, or a predicted student success indicator. See at least FIG. 9.

As shown by operation 604, the service provider system 106, such as apparatus 500, includes means, such as processor 512, memory 514, user interface 516, communication interface 518, and/or the like, for facilitating interaction, via an advisor-facing user interface and a student-facing user interface, and between at least one student-user and at least one advisor-user, relating to the at least one of the one or more advisor-facing metrics relating to student progress, or the one or more student-facing metrics relating to student progress. The interaction may be facilitated via one or more displays, such as those of FIGS. 9-14, for example.

As shown by operation 606, the service provider system 106, such as apparatus 500, includes means, such as processor 512, memory 514, user interface 516, communication interface 518, and/or the like, for, via the administrator-facing user interface, enabling (a) configuration of data used by the model, and (b) finetuning of parameters used by the model via the administrator-facing user interface. See, for example, the displays of FIGS. 16A-16G.

As shown by operation 608, the service provider system 106, such as apparatus 500, includes means, such as processor 512, memory 514, user interface 516, communication interface 518, and/or the like, for configuring various instances of the model for different institutional systems. In this regard, displays such as those of FIGS. 16A-16G may be used to configure different institutional systems for their specific infrastructure, data types, and use cases. The model configured at different institutional systems may vary. For example, different features may have different importance at different institutions or in different demographics, as determined by the machine learning model when processing such data within a unique institutional system. The variance of such features and their varying weights across different institutional systems further emphasizes the significance of implementing example embodiments using a machine learning model and provides an improvement over prior systems and/or traditional ERP software that are less portable between institutions, and/or fail to account for different weights of features that impact student success predictions.

As shown by operation 610, the service provider system 106, such as apparatus 500, includes means, such as processor 512, memory 514, user interface 516, communication interface 518, and/or the like, for enabling further configuration of one or more instances of the model via an administrator-facing user interface. See, for example, the administrator-facing user interfaces of FIGS. 16A-16G.

As shown by operation 612, the service provider system 106, such as apparatus 500, includes means, such as processor 512, memory 514, user interface 516, communication interface 518, and/or the like, for generating an insight regarding an impact of one of more student-specific academic data, student-specific financial data, or institutional policy data in predicting student-specific outcomes. The processor 512 may identify certain insights, such as an impact that an introduction of a new class in a certain degree has on a predicted student success indicator. As another example, the machine learning model, with processor 212, may identify a correlation of a poor grade or poor cumulative GPA (e.g., below a certain or predefined threshold) in a most recent semester when only a certain number of Pell grant semesters remain (e.g., below a certain or predefined threshold) have a significant impact on the predicted student success indicator. Any combination of data and impact to an outcome may be identified, and may vary across cohorts, demographics, majors, institutions, and/the like, such that implementing example embodiments in a systematic machine learning environment provide improved insights and outputs in comparison to prior systems and/or traditional ERP software. Utilizing the machine learning environment according to example embodiments generates more accurate insights within targeted populations in comparison to prior systems that merely provide static metrics and/or reports or cannot generate such intelligent insights. For example, the online learning components of example embodiments enable generation of real-time or time-sensitive insights.

As shown by operation 614, the service provider system 106, such as apparatus 500, includes means, such as processor 512, memory 514, user interface 516, communication interface 518, and/or the like, for, applying a large language model to the model to generate one or more natural language feedback strings pertaining to a student-specific scenario. In this regard, an advisor-user and/or student-user may engage in a chat session with a chat bot to obtain one or more respective advisor-facing metrics and/or students-facing metrics. See also FIG. 8.

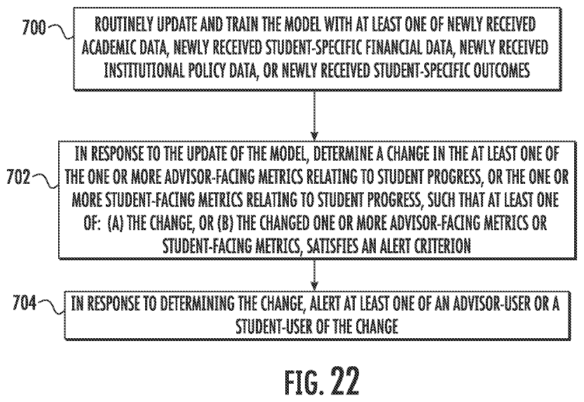

FIG. 22 shows operations performed according to example embodiments. As shown by operation 700, the service provider system 106, such as apparatus 500, includes means, such as processor 512, memory 514, user interface 516, communication interface 518, and/or the like, for routinely updating and training the model with at least one of newly received academic data, newly received student-specific financial data, newly received institutional policy data, or newly received student-specific outcomes. Even if one were to consider manually, or partially manually generating a model and training the model with known historical data, routinely updating and training the model over time with newly received data would be nearly impossible and certainly impractical to implement manually. For example, information pertaining to students' financial situation, grades, institutional policy, and/or the like is constantly changing and impacting student success in different ways, such that a human or manually implemented solution would not feasibly nor efficiently identify changing factors impacting a student's success. As another example, at the end of a semester, or upon graduation of a certain class, large amounts of data pertaining to student success outcomes become available such that retraining a model manually would be impractical, and so time consuming to the extent that such attempts would likely not arrive at the same insights produced by the online implementation provided by example embodiments, nor arrive at such insights in a quick enough manner as to alert advisors of newly identified at-risk students, or environmental factors in the academic environment having a significant impact to students. In this regard and according to example embodiments, configuring file locations within an institutional system, such as with administrator-facing user interface displays of FIGS. 16A-16G, supports routinely updating and training the model over time with newly received data. Example embodiments can therefore be configured to routinely update and retrain the model as new data is populated into certain databases and/or files. See also controllers 68 of FIGS. 3 and 4, the running process 84 of FIG. 4, and/or the like.

As shown by operation 702, the service provider system 106, such as apparatus 500, includes means, such as processor 512, memory 514, user interface 516, communication interface 518, and/or the like, for in response to the update of the model, determine a change in the at least one of the one or more advisor-facing metrics relating to student progress, or the one or more student-facing metrics relating to student progress, such that at least one of: (a) the change, or (b) the changed one or more advisor-facing metrics or student-facing metrics, satisfies an alert criterion. As shown by operation 704, the service provider system 106, such as apparatus 500, includes means, such as processor 512, memory 514, user interface 516, communication interface 518, and/or the like, for, in response to determining the change, alerting at least one of an advisor-user or a student-user of the change. In this regard, as set forth above, implementing example embodiments in an online environment in which new data and changes thereof update the model in real-time or near real-time, enables students and/or advisors to be alerted of potential risks as soon as they are detected. For example, if failure of a certain class has previously resulted in students needing beyond 4 years to graduate, a poor grade in such a class, either at semester end or mid-semester, could trigger an alert to a student and/or advisor. In this regard, if an alert criterion is satisfied, such as a predicted quantitative indicator (e.g. probability of graduating within 4 years) falling below a predefined or configured threshold, an alert may be generated. As another example, if a predicted student success indicator shifts into a different category or below a threshold, an alert may be generated. Any types of measures and/or variations of alert criterion may be contemplated according to example embodiments and may be provided via an advisor-facing and/or student-facing user interface. See also the controller 68 notification toward API 16 in FIG. 4, further enabling configuration and/or customization at the institutional level. Alerts via email, via text messaging, and/or via other electronic communication types may be contemplated.

Example embodiments therefore provide distinct technical advantages and improvements over prior systems and traditional ERP software. The online machine learning environment of example embodiments enables an efficient, large-scale ingestion, feature analysis, and discovery across different cohorts, degrees, demographics, institutions, and/or the like. The complexity and variance across different institutional systems and their respective data architectures has previously impeded such progress of ERP systems, but example embodiments address these technical challenges through the scalable, portable, and configurable systems disclosed herein while the secure integration into existing systems is easy to implement to support data privacy. Additionally, example embodiments leverage student financial data in a unique way (financial data that was previously limited and/or absent from prior systems due to privacy laws), by incorporating financial data in backend online machine learning processes without necessarily directly exposing financial data to advisor-users—or, when permitted by the student-user to further facilitate student-advisor interactions via user interfaces, providing student financial data to advisors. Example embodiments therefore provide technical improvements over prior systems, and further provide a computer-based solution that can't be practically replicated nor routinely updated by human-implemented or routine/traditional computer-implemented methods. This can provide an enormous set of data and reports to higher education administrators to make proper strategic decisions about students' success as far as students progress and graduation.

FIGS. 21 and 22 illustrate operations of a method, apparatus, and computer program product according to some example embodiments. It will be understood that each operation of the flowchart or diagrams, and combinations of operations in the flowchart or diagrams, may be implemented by various means, such as hardware and/or a computer program product comprising one or more computer-readable mediums having computer readable program instructions stored thereon. For example, one or more of the procedures described herein may be embodied by computer program instructions of a computer program product. In this regard, the computer program product(s) which embody the procedures described herein may comprise one or more memory devices of a computing device (for example, memory 514) storing instructions executable by a processor in the computing device (for example, by processor 512). In some example embodiments, the computer program instructions of the computer program product(s) which embody the procedures described above may be stored by memory devices of a plurality of computing devices. As will be appreciated, any such computer program product may be loaded onto a computer or other programmable apparatus (for example, apparatus 500) to produce a machine, such that the computer program product including the instructions which execute on the computer or other programmable apparatus creates means for implementing the functions specified in the flowchart block(s). Further, the computer program product may comprise one or more computer-readable memories on which the computer program instructions may be stored such that the one or more computer-readable memories can direct a computer or other programmable apparatus to function in a particular manner, such that the computer program product may comprise an article of manufacture which implements the function specified in the flowchart block(s). The computer program instructions of one or more computer program products may also be loaded onto a computer or other programmable apparatus (for example, apparatus 500 and/or other apparatus) to cause a series of operations to be performed on the computer or other programmable apparatus to produce a computer-implemented process such that the instructions which execute on the computer or other programmable apparatus implement the functions specified in the flowchart block(s).

Accordingly, blocks of the flowchart support combinations of means for performing the specified functions and combinations of operations for performing the specified functions. It will also be understood that one or more blocks of the flowchart, and combinations of blocks in the flowchart, can be implemented by special purpose hardware-based computer systems which perform the specified functions, or combinations of special purpose hardware and computer instructions.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

1. An apparatus comprising at least one processor and at least one memory including computer program code, the at least one memory and the computer program code configured to, with the processor, cause the apparatus to at least:
access a model trained with at least historical student-specific academic data, historical student-specific financial data, historical institutional policy data, and historical student-specific outcomes; and
apply to the model at least one set of subject student-related academic data and subject student-related financial data to generate at least one of: (a) one or more advisor-facing metrics relating to student progress, or (b) one or more student-facing metrics relating to student progress.

2. The apparatus according to claim 1, wherein the one or more student-facing metrics indicate a financial estimate pertaining to completion of a degree and are provided via a student-facing user interface, wherein the student-facing user interface further enables a student-user to configure a student-specific academic plan.

3. The apparatus according to claim 2, wherein the at least one memory and the computer program code are further configured to, with the processor, cause the apparatus to at least:
via the student-facing user interface, enable a student-user to authorize an advisor-user to access the subject student-related financial data.

4. The apparatus according to claim 1, wherein the one or more advisor-facing metrics indicate at least one of a student-specific academic plan progress status, or a predicted student success indicator, and are provided via an advisor-facing interface.

5. The apparatus according to claim 4, wherein the predicted student success indicator comprises a two-tier hierarchical predictor indicating whether or not a student is predicted to graduate, and if so, whether the student will graduate within a predetermined time period.

6. The apparatus according to claim 1, wherein the at least one memory and the computer program code configured to, with the processor, cause the apparatus to at least:
facilitate interaction, via an advisor-facing user interface and a student-facing user interface, and between at least one student-user and at least one advisor-user, relating to the at least one of the one or more advisor-facing metrics relating to student progress, or the one or more student-facing metrics relating to student progress.

7. The apparatus according to claim 1, wherein the at least one memory and the computer program code are further configured to, with the processor, cause the apparatus to at least:
via an administrator-facing user interface, provide configuration information relating to the training of the model; and
via the administrator-facing user interface, enable (a) configuration of data used by the model, and (b) finetuning of parameters used by the model.

8. The apparatus according to claim 1, wherein the at least one memory and the computer program code are further configured to, with the processor, cause the apparatus to at least:
routinely update and train the model with at least one of newly received academic data, newly received student-specific financial data, newly received institutional policy data, or newly received student-specific outcomes.

9. The apparatus according to claim 1, wherein the historical student-specific academic data, historical student-specific financial data, historical institutional policy data, and historical student-specific outcomes are provided from disparate systems.

10. The apparatus according to claim 1, wherein the apparatus wherein the at least one memory and the computer program code are further configured to, with the processor, cause the apparatus to at least:
configure various instances of the model for different institutional systems; and
enable further configuration of one or more instances of the model via an administrator-facing user interface.

11. The apparatus according to claim 1, wherein the apparatus wherein the at least one memory and the computer program code are further configured to, with the processor, cause the apparatus to at least:
generate an insight regarding an impact of one of more student-specific academic data, student-specific financial data, or institutional policy data in predicting student-specific outcomes.

12. The apparatus according to claim 1, wherein the apparatus wherein the at least one memory and the computer program code are further configured to, with the processor, cause the apparatus to at least:
apply a large language model to the model to generate one or more natural language feedback strings pertaining to a student-specific scenario.

13. The apparatus according to claim 1, wherein the apparatus wherein the at least one memory and the computer program code are further configured to, with the processor, cause the apparatus to at least:
update the model with at least one of newly received academic data, newly received student-specific financial data, newly received institutional policy data, and newly received student-specific outcomes;
in response to the update of the model, determine a change in the at least one of the one or more advisor-facing metrics relating to student progress, or the one or more student-facing metrics relating to student progress, such that at least one of: (a) the change, or (b) the changed one or more advisor-facing metrics or student-facing metrics, satisfies an alert criterion; and
in response to determining the change, alert at least one of an advisor-user or a student-user of the change.

14. A computer-implemented method comprising:
accessing a model trained with at least historical student-specific academic data, historical student-specific financial data, historical institutional policy data, and historical student-specific outcomes; and
applying to the model at least one set of subject student-related academic data and subject student-related financial data to generate at least one of: (a) one or more advisor-facing metrics relating to student progress, or (b) one or more student-facing metrics relating to student progress.

15. The computer-implemented method according to claim 14, wherein the one or more student-facing metrics indicate a financial estimate pertaining to completion of a degree and are provided via a student-facing user interface, wherein the student-facing user interface further enables a student-user to configure a student-specific academic plan.

16. The computer-implemented method according to claim 15, further comprising:
via the student-facing user interface, enabling a student-user to authorize an advisor-user to access the subject student-related financial data.

17. The computer-implemented method according to claim 1, wherein the one or more advisor-facing metrics indicate at least one of a student-specific academic plan progress status, or a predicted student success indicator, and are provided via an advisor-facing interface.

18. The computer-implemented method according to claim 17, wherein the predicted student success indicator comprises a two-tier hierarchical predictor indicating whether or not a student is predicted to graduate, and if so, whether the student will graduate within a predetermined time period.

19. The computer-implemented method according to claim 17, further comprising:
facilitating interaction, via an advisor-facing user interface and a student-facing user interface, and between at least one student-user and at least one advisor-user, relating to the at least one of the one or more advisor-facing metrics relating to student progress, or the one or more student-facing metrics relating to student progress.

20. A computer program product comprising at least one non-transitory computer-readable storage medium having computer-executable program code instructions stored therein, the computer-executable program code instructions comprising program code instructions to:
access a model trained with at least historical student-specific academic data, historical student-specific financial data, historical institutional policy data, and historical student-specific outcomes; and
apply to the model at least one set of subject student-related academic data and subject student-related financial data to generate at least one of: (a) one or more advisor-facing metrics relating to student progress, or (b) one or more student-facing metrics relating to student progress.
